(19) United States
(12) Patent Application Publication
(10) Pub. No.: US 2004/0145344 A1
(43) Pub. Date: Jul. 29, 2004

(54) Method and apparatus for regulating charging of electrochemical cells

(76) Inventors: William C. Bushong, Madison, WI (US); Paul Cheeseman, Verona, WI (US); Greg Davidson, Oregon, WI (US); Tom Kaufman, Middleton, WI (US); Richard Mank, Madison, WI (US); Michael Root, Lino Lakes, MN (US); Aaron Rositch, Edgerton, WI (US); Viet H. Vu, Verona, WI (US)

Correspondence Address: QUARLES & BRADY LLP, 411 E. WISCONSIN AVENUE, SUITE 2040, MILWAUKEE, WI, 53202-4497, US

(21) Appl. No.: 10/697,221

(22) Filed: Oct. 27, 2003

Related U.S. Application Data
(63) Continuation-in-part of application No. 10/045,934, filed on Oct. 19, 2001.
(60) Provisional application No. 60/421,624, filed on Oct. 25, 2002.

(51) Int. Cl. H02J 7/00

(52) U.S. Cl. 320/112

(57) ABSTRACT

A rechargeable electrochemical cell is provided having a pressure-responsive apparatus for determining a charge termination point. In particular, a reversible pressure-responsive switch may be disposed in a cap at the open end of a rechargeable metal hydride cell. The reversible pressure-responsive switch may also contain a vent system for releasing the cell internal pressure. Additionally, a rechargeable cell is used combination with a charging source that can supply constant voltage, constant current, alternating current, or voltage that varies between a minimum threshold and a maximum threshold. Components of the switch are preferably made of a material that facilitates predictable switch activity.

### CROSS-REFERENCE TO RELATED APPLICATIONS

This is a continuation-in-part of U.S. Ser. No. 10/045,934 filed Oct. 19, 2001 and entitled “Method and Apparatus for Regulating Charging of Electrochemical Cells”, and further claims priority to provisional U.S. S No. 60/421,624 filed Oct. 25, 2002, the disclosures of each of which are hereby incorporated by reference as if set forth in their entirety herein.

### STATEMENT REGARDING FEDERALLY SPONSORED RESEARCH OR DEVELOPMENT

--

### BACKGROUND OF THE INVENTION

The present invention relates generally to nickel rechargeable cells, such as nickel metal hydride (NiMH) cells, and more specifically to a method and apparatus for automatically reversibly terminating a cell charging process. This invention may also be employed in nickel cadmium (NiCd) cells.

For greater convenience and portability, many modern electrical appliances and consumer products may be operated to draw electric current from batteries of standard size and electrical performance. For convenience and economy, various rechargeable batteries have been developed, such as nickel metal hydride cells and the like.

Metal hydride cell technology provides excellent high-rate performance at reasonable cost when compared to nickel cadmium and lithium ion technology. Moreover, metal hydride cells have about a 50% higher volumetric energy density than NiCd cells and about equal to lithium ion cells. The internal chemistry of metal hydride rechargeable cells has an impact on the ability to charge such cells. Issues affecting the ability to charge nickel rechargeable cells arise as a result of the internal chemistry of such cells. When a nickel rechargeable cell approaches a full charge state, oxygen is generated at the positive electrode as follows:

4OH⁻→O₂(gas)+2H₂O+4e⁻

The oxygen gas diffuses across a gas-permeable separator to the negative electrode where it is recombined into cadmium hydroxide or water as follows:

½O₂(gas)+H₂O+Cd→Cd(OH)₂+Heat @ Cadmium negative electrode

½O₂(gas)+H₂→H₂O+Heat @ Hydride negative electrode

When recharging such cells, it is important to ascertain when the cell has become fully charged. For example, if a cell were to become overcharged for an extended period of time, the pressure buildup within the cell could cause the cell to fail as well as electrolyte to leak, thereby further subjecting the charger to potential damage.

Metal hydride rechargeable cells are typically recharged by applying a constant current rather than constant voltage to the cells. In this scheme, cell voltage increases gradually until the cell approaches full charge whereupon the cell voltage peaks. As the cells reach the overcharge state, the released heat causes the cell temperature to increase dramatically, which in turn causes the cell voltage to decrease. Cell pressure also rises dramatically during overcharge as oxygen gas is generated in quantities larger than the cell can recombine. Unfortunately, it is known that the rate of pressure change is several orders of magnitude faster than the rate of voltage or temperature change. Thus, conventional constant current charge interruption methods cannot support a very fast charge rate without risking internal pressure buildup, rupture, and electrolyte leakage. For this reason, metal hydride cells may be provided with safety vents.

One common way to reduce pressure buildup at the full-charge state is to provide a negative electrode having an excess capacity of greater by 40-50% more than the positive electrode, a gas-permeable separator, and limited electrolyte to accommodate effective diffusion of gasses. This avoids the production of hydrogen gas at the negative electrode while permitting the oxygen to recombine with the negative electrode material. When a cell reaches full charge, oxygen gas continues to be produced at the positive electrode, but hydrogen is not produced from the negative electrode. If hydrogen were produced, the cell could rupture from excess pressure. The oxygen recombination reaction therefore controls the cell pressure, as is illustrated in FIG. 1. The oxygen gas then crosses the separator and reacts with the negative electrode material. Detrimental aspects of this arrangement include reduced cell capacity and corresponding shorter cell cycle life due to degradation of the negative electrode from overcharge with oxidation and heat.

It is important to stop charging a cell or plurality of cells when a full charge state is reached to avoid possible cell rupture or leakage due to the increasing internal gas pressure. Conventional metal hydride rechargeable cells cannot themselves signal a suitable charge termination point. One must instead rely upon expensive and sophisticated detection circuitry in an associated charger device to determine when charging should end. Charge termination is typically determined by the detection circuitry based on (1) peak cell voltage, (2) peak cell temperature (TCO), (3) duration of charging time, (4) −dV, and (5) dT/dt. Each known method for terminating a constant current charge has disadvantages. For example, time-based termination can be unreliable except at very low charge rates because the cell can become overcharged before termination.

Charge termination based on peak voltage can be unreliable at the end of the charging period because an over-voltage condition can exist before termination. Termination based on a voltage decline (−dV) is necessarily associated with oxygen recombination and the accompanying detrimental temperature rise. In practice, this means that voltage detection must be accurate and fast. Unless the ambient temperature is steady, it can be difficult to accurately measure a change in voltage. Moreover, when the charge rate is slower than 0.3 C, the voltage drop measurement is too small to be detected accurately. By definition, a charge rate of 1C draws in one hour of constant charge a current substantially equal (e.g., within 80%) to the rated discharge capacity of the electrochemical cell or battery. Termination based only on peak temperature is also easily affected by ambient temperature changes.

Termination based upon the rate of change in temperature over time (dT/dt) is somewhat more reliable than detecting an absolute temperature change because it is less subject to effects caused by ambient temperature change and because there is less negative effect on cycle life, but it is still based on heat which is detrimental to cell performance and cycle life. This is because temperature increases faster, and, in fact, precedes, the drop in voltage. Accordingly, there is somewhat less risk of rupture and leakage than in the other methods noted above. This makes it the most common charge termination method in use today.

Others in the art have sought pressure-based mechanisms for breaking the connection between the electrode and the cell terminal when pressure exceeds a predetermined level. For example, U.S. Pat. No. 5,026,615 discloses a pressure-sensitive switch in an end cap assembly that comprises a conductive spring member, a nonconductive fulcrum member and a moveable conductive member. The conductive spring member is in electrical connection with a terminal on one end and with the moveable conductive member on the other end. The moveable conductive member is in turn in electrical connection with an electrode. As the internal cell pressure increases, the moveable conductive member exerts force on the spring member, which pivots on the nonconductive fulcrum member and disconnects from the terminal. This patent therefore requires a first and second contact, one of which being movable with respect to the other and rotatable about a fulcrum in order to pivot with respect to the other contact. This arrangement requires more essential parts than necessary, and further requires that the assembly be constructed with tight tolerances, thereby increasing complexity as well as the cost of production.

Other examples of these technologies include U.S. Pat. Nos. 5,747,187, 5,405,715, 5,741,606, 5,609,972, 6,018,286, 6,078,244, and 6,069,551, all of which are incorporated herein by reference as if set forth in their entirety. Some such mechanisms prevent a pressure-induced rupture of the cell but in doing so permanently disable the cell. In other cases, reversible switch devices prevent cell rupture, but do not detect an early charge termination state to avoid heat build up and to ensure superior cell performance and cycle life.

With constant voltage charge, on the other hand, the charging current is high at the beginning of the charge, when the cell can accept higher currents, and then decreases to lower levels as the cell approaches full charge. When constant voltage charging, the above-noted signals for the end of a constant current charge process are not useful because as the cell approaches the full charge state, the cell voltage is constant and the cell temperature is leveling. Like a constant current charge approach, charging time cannot be used for the constant voltage charge when the charge rate is higher than 0.3C due to run away of pressure that can damage the cell and the charger. As a result of these shortcomings it has been difficult to identify an effective termination signaling means and constant voltage charging for metal hydroxide cells has therefore been generally considered to be impractical.

With alternating current charge, the charging current may be modulated at a defined frequency or combination of frequencies to produce a net positive current that enables the cell to become charged. An alternating current charge can provide a fast charge with less pressure buildup and lower temperature increase than constant current or constant voltage charge. However, when using an alternating current charge, the above-noted signals for the end of a constant current charge process are not useful because as the cell approaches the full charge state, changes in the cell voltage are difficult to detect above the voltage response to the applied alternating current. As a result it has been difficult to identify an effective termination signaling means and alternating current charging for metal hydroxide cells has also therefore been generally considered to be impractical. It should be appreciated that an alternating current charge is used throughout the present disclosure to mean a varying current that produces a net positive charge, such as a modulated alternating current. For example, an alternating current may be half-wave rectified or full-wave rectified to produce a series of current pulses, or an alternating current may be offset by a desired DC current.

Published Australian patent application number 199926971 A1 discloses a method for fast charging a nickel metal hydride battery in an implant by transcutaneous transmission of electric power from an external power-transmission part to a power-receiving part in the implant. The patent application considers the desirability of an initial rapid high-current charge phase when the internal cell resistance is low, followed by a second lower-current, constant cell voltage charge phase to ensure that the cell is charged only with as much energy as the electrochemical state allows, without excess gassing or heating of the cell. Harmful effects on the battery are precluded while, at the same time, the charging rate remains high. In the method disclosed therein, a first of two charging phases includes the step of allowing a relatively high constant charging current to flow to the power receiving part while the cell voltage rises until it reaches a predetermined limiting charging voltage. In the second charging phase, the charging current is lower than the current level at the end of the first phase while the cell voltage is kept at least approximately at the predetermined constant voltage value. In the Australian patent application, the second charge phase ends when an associated micro-electronic controller determines that the rate of change of the charging current over time does not reach a predetermined slope. This cumbersome two-step constant current/constant voltage approach is typical of prior approaches in the art.

In summary, as the metal hydride rechargeable cell reaches its fully charged state, oxygen is evolved from the positive electrode, thereby increasing the internal cell pressure and driving the exothermic oxygen recombination reaction. At a very high constant current charge rate, usually less than one hour, charge current is still very high at the end of charge. This results in severe heating of the cell and shortened cycle life. The available methods of terminating constant current charge are not very reliable when cell temperature is high. In addition, cell heating is detrimental and it is desirable to terminate the charge before significant cell heating at the stage where damaging pressure begins to rise within the cell.

What is therefore needed is a method and apparatus for more accurately determining the charge termination point for a cell that is fully rechargeable under constant voltage, constant current, and alternating current/voltage charging.

What would be desirable is a reversible regulating switch that is responsive to a stimulus for determining a charge termination point that is less complex and less destructive than those currently available.

What is also desirable is a more cost-efficient and reliable charge termination detection apparatus than that currently achieved, and that is compatible with conventional rechargeable batteries.

### BRIEF SUMMARY OF THE INVENTION

In one aspect the invention provides an axially extending rechargeable electrochemical cell including an outer can that defines an internal cavity with an open end, a positive and negative electrode disposed in the internal cavity, and a terminal end cap enclosing the open end. The cell has an end cap assembly that includes a flexible member formed from a material having a heat deflection temperature greater than 100 C at 264 PSI and a tensile strength greater than 75 Mpa. The flexible member extends radially inwardly from the can and flexes from a first position towards a second position in response to internal cell pressure. The end cap assembly further includes a first conductive element in electrical communication with the terminal end cap. The end cap assembly also includes a second conductive element in electrical communication with the positive electrode, and in removable electrical communication with the first conductive element. The second conductive element is in mechanical communication with the flexible member. The first and second conductive elements are removed from electrical communication when the flexible member flexes towards the second position in response to an internal pressure exceeding a predetermined threshold.

The foregoing and other aspects of the invention will appear from the following description. In the description, reference is made to the accompanying drawings which form a part hereof, and in which there is shown by way of illustration, and not limitation, a preferred embodiment of the invention. Such embodiment does not necessarily represent the full scope of the invention, however, and reference must therefore be made to the claims herein for interpreting the scope of the invention.

### BRIEF DESCRIPTION OF THE SEVERAL VIEWS OF THE DRAWINGS

FIG. 1 is a schematic illustration of the oxygen recombination reaction controlling cell pressure;

FIG. 2A is a cross-sectional view of an end cap assembly containing a pressure-responsive switch and a pressure-release vent constructed in accordance with a preferred embodiment of the invention, illustrated in a low pressure position;

FIG. 2B is a cross-sectional view of the end cap assembly illustrated in FIG. 2A in a high pressure position;

FIG. 3 is a cross-sectional isometric view of an end cap assembly containing a pressure-responsive switch and a pressure-release vent constructed in accordance with an alternate embodiment of the invention, depicted in a low pressure position;

FIG. 4 is a cross-sectional elevation view of the end cap assembly of FIG. 3;

FIG. 5 depicts an exploded view of the components of the end cap assembly of FIG. 3;

FIG. 6A is a sectional side elevation view of the positive terminal of a cell incorporating a switch constructed in accordance with an alternate embodiment of the invention;

FIG. 6B is a view similar to FIG. 6A, but constructed in accordance with an alternate embodiment of the invention.

FIG. 7 is a sectional side elevation view of the positive terminal of a cell incorporating a switch constructed in accordance with an alternate embodiment of the invention;

FIG. 8 is a graph plotting capacity (Ah) vs. AP (psig) for a nickel metal hydride cell during alternating current and constant current charge;

FIG. 9 is a graph plotting capacity (Ah) vs. AP (psig) for a nickel metal hydride cell during alternating current and constant voltage charge;

FIG. 10 is a graph plotting internal cell pressure (psig) vs. time (min) for a plurality of cells constructed in accordance with the preferred embodiment;

FIG. 11 is a graph plotting pressure, temperature, and voltage vs. time (min) for a cell during charging using a constant current charge, and subsequent discharging;

FIG. 12 is a graph plotting internal pressure (psig) vs. time (min) for various cycles during charging using a constant current charge, and subsequent discharging;

FIG. 13 is a graph plotting the pressure rise for the cell illustrated in FIG. 12 during charging;

FIG. 14 is a graph plotting pressure fall for the cell illustrated in FIG. 12 during discharging;

FIG. 15 is a graph plotting pressure and temperature vs. time for cells at different cycles under a constant current charge;

FIG. 16 is a graph plotting pressure vs. time for a plurality of cells at different cycles under a constant current charge;

FIG. 17 is a graph plotting pressure, temperature, and current vs. time for plurality of cells under a constant voltage charge.

FIG. 18 is a graph plotting and comparing internal pressure vs. applied charge capacity during constant current charging versus constant voltage charging;

FIG. 19 is a graph illustrating and comparing the current profile of two cells during charging under constant voltage versus constant current.

FIG. 20 is a graph plotting and comparing cell temperature vs. capacity for two cells charged under constant current versus constant voltage, respectively;

FIG. 21 is a graph plotting and comparing the voltage profile vs. time for the two cells illustrated in FIG. 20;

FIG. 22 is a graph plotting and comparing temperature and capacity vs. time during charging under varying constant voltages

FIG. 23 is a sectional side elevation view of an end cap assembly containing a pressure-responsive switch and a pressure-release vent constructed in accordance with an alternate embodiment of the invention, illustrated in a low pressure position;

FIG. 24 is a sectional side elevation view of an end cap assembly containing a pressure-responsive switch and a pressure-release vent constructed in accordance with another alternate embodiment of the invention, illustrated in a low pressure position;

FIG. 25 is a sectional side elevation view of an end cap assembly containing a pressure-responsive switch and a pressure-release vent constructed in accordance with yet another alternate embodiment of the invention, illustrated in a low pressure position;

FIG. 26A is a schematic view of a battery pack constructed in accordance with one embodiment of the present invention;

FIG. 26B is a schematic view of a battery pack constructed in accordance with an alternate embodiment of the present invention;

FIG. 26C is a schematic view of a battery pack constructed in accordance with another alternate embodiment of the present invention;

FIG. 27 is a graph illustrating the charge and discharge capacity for battery packs having matched and mismatched cells;

FIG. 28A is a graph illustrating % elongation at break vs. tensile strength for polymers usable in rechargeable cells in accordance with a preferred embodiment of the present invention;

FIG. 28B is a graph illustrating heat deflection temperature vs. tensile strength for polymers usable in rechargeable cells in accordance with a preferred embodiment of the present invention;

FIG. 29 is a graph illustrating charge capacity vs. charge time for rechargeable NiMH cells having a reduced active volume in accordance with an alternate embodiment of the present invention;

FIG. 30 is a chart comparing characteristics of a NiMH size AA cell constructed in accordance with the embodiment described with reference to FIG. 29 compared to supercapacitors having similar volume;

FIGS. 31A-B illustrate an assembly of a battery pack constructed in accordance with one embodiment of the present invention;

FIGS. 32A-B illustrate an assembly of a battery pack constructed in accordance with an alternate embodiment of the present invention; and

FIGS. 33A-C illustrate various embodiments that produce cell electrodes with reduced electrode volumes.

### DETAILED DESCRIPTION OF THE PREFERRED EMBODIMENT

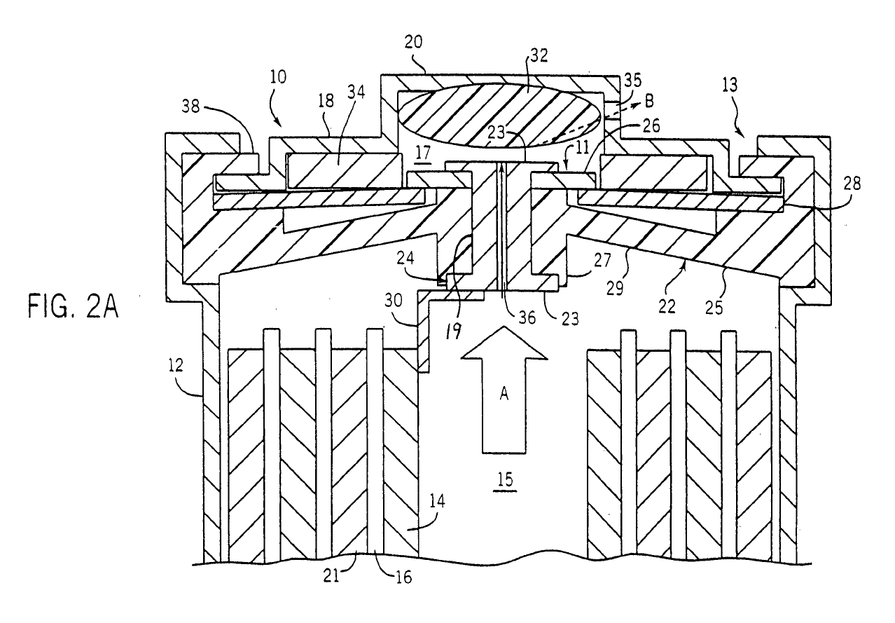

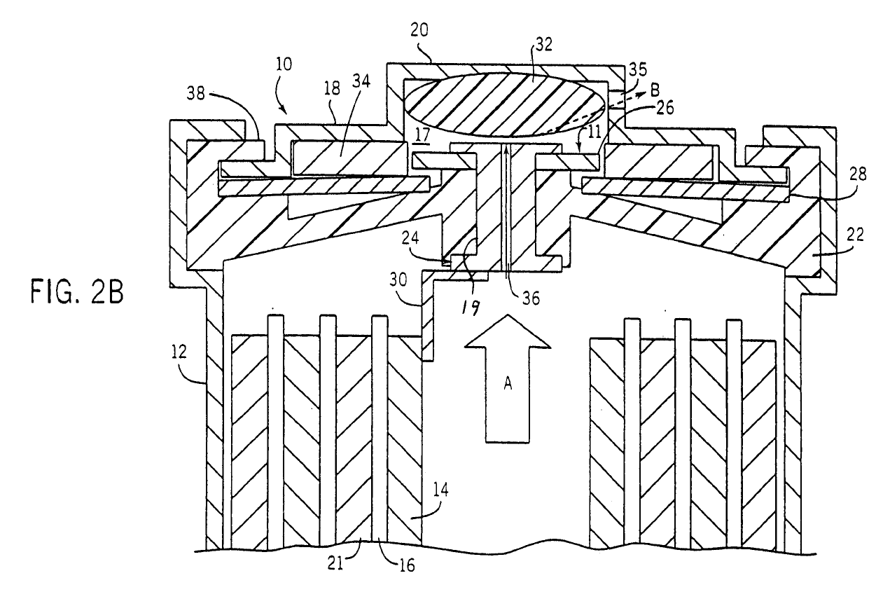

Referring now to FIG. 2A, an axially extending cell includes a can 12 having closed end (not shown) and an open end 13 disposed opposite the open end and axially downstream therefrom. A cap assembly 10 includes a positive terminal end cap 18 that is secured in the open end of the negative can 12 to provide closure to the cell. In particular, the end cap assembly 10 and the open end of the can 12 are adapted in size and shape such that the end cap assembly 10 is sealingly accommodated in the open end by crimping the negative can 12 during assembly of a cylindrical rechargeable metal hydride cell. The closed end of the can is conventional and is not shown.

A positive (e.g., nickel hydroxide) electrode 14 is in removable electrical connection with the positive terminal cap 18, as will become more apparent from the description below. The cell further contains a negative electrode 21 (e.g., hydride electrode) that is in electrical connection with the can 12, and an alkaline electrolyte (e.g., potassium hydroxide) alone or in combination with other alkali metal hydroxides. The electrodes are disposed in an internal cavity 15, and are separated by a separator 16. A cell comprising the can 12 and the end cap assembly 10 of the invention can further comprise conventional positive 14 and negative 21 wound electrodes in its interior, although the relative size of these electrodes can be adjusted to meet the physical and electrical specifications of the cell.

The positive terminal cap 18 has a nubbin 20 that is sized and shaped to provide a positive terminal to the cell having a pressure-responsive switch 11 constructed in accordance with the present invention. The pressure-responsive switch 11 comprises a flexible nonconductive mono-stable grommet 22 adapted in size and shape to fit securely in the open end 13. Grommet includes a radially outer seal 25, an inner hub 27, and an arm 29 that extends substantially radially and connects the seal to the hub. It should be appreciated that arm 29 extends radially throughout the cell and, accordingly, the terms “arm” and “disc” are to be used interchangeably throughout this disclosure. Grommet 22 further includes has a centrally disposed opening 19 extending axially through the hub 27 in which is seated a conductive spool-shaped connector 24 having a pair of oppositely disposed radially extending outer flanges 23. The space between the outer surface of grommet 22 and inner surface of terminal end cap 18 defines a cavity 17 in the end cap assembly 10.

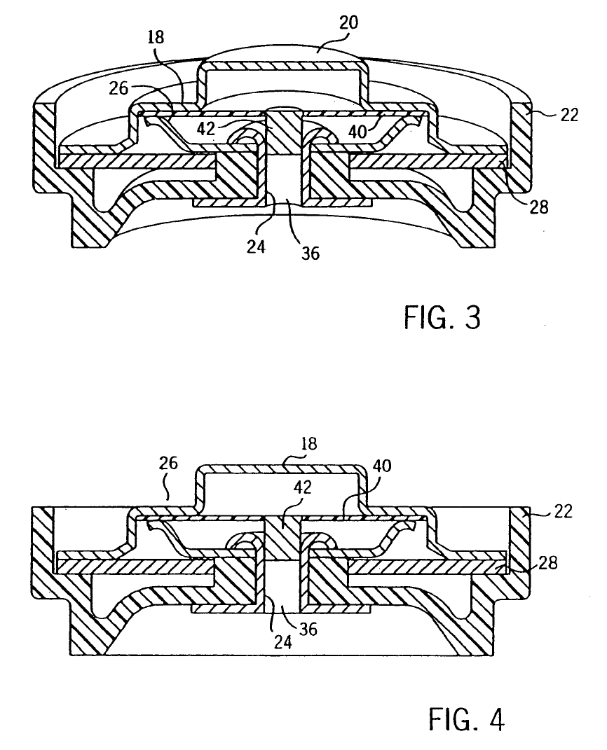

Connector 24 is securely fixed in the opening 19 of grommet 22 such that the conductive connector moves in concert with the grommet. A first annular conductive contact 26, which is a metal washer in accordance with the illustrated embodiment, surrounds the hub of connector 24 and has an upper surface in electrical contact with the upper flange 23. A second annular conductive contact 28 (which can also be a metal washer) surrounds the grommet and is positioned axially upstream and adjacent the first contact 26. The first and second contacts 26, 28 are circular plates in FIG. 2A but they can be provided in other shapes, as illustrated, for example, in FIGS. 3-5. Contact 28 has an upper surface 29 that is in electrical connection with the terminal cap, and in removable mechanical (and therefore electrical) connection with the bottom surface of the first contact 26, as will become more apparent from the description below.

The grommet 22 can be formed of any sufficiently flexible, nonconductive inert material that does not adversely impact the cell chemistry. Suitable materials include but are not limited to polypropylene, polyolefin, and nylon, including glass filled nylon and other glass filled polymers, as will be described in more detail below.

The outer seal 25 of grommet 22 includes an upwardly and radially inwardly extending peripheral lip 38 that is shaped and sized to form a tight seal with the open end of the can to provide a barrier between the interior and the exterior of the cell. The lip 38 also partially defines a cavity in the outer seal 25 in which the outer end of terminal end cap 18 and second contact 28 are disposed. The lip 38 presents a radially outer convex surface to permit the can 12 to be crimped over the grommet 22 during assembly of the cell. When the axially downstream end of can 12 is crimped over the grommet 22 during assembly, a tight seal is provided between the grommet 22, second contact 28, and terminal end cap 18 to isolate the interior of the cell from the ambient environment. An optional sealant such as asphalt or tar can also be employed between the end cap assembly 10 and the can 12 to strengthen the seal.

A flexible conductive tab 30 electrically connects the conductive connector 24 to the positive electrode 14 in the interior of the cell. The conductive connector 24 can be an eyelet or rivet that is secured in the central opening 19 by crimping at its ends to provide flanges 23 that secure the hub 27 of grommet 22 and the first contact 26. The conductive connector 24 is in electrical and physical contact with the first contact 26 thereby helping to secure the conductive connector 24 into position.

FIG. 2A illustrates the end cap assembly in a low pressure state, such that the grommet 22 is in its stable position. In this low pressure state, the positive electrodes 14 are in electrical connection with the positive terminal cap 18 via the conductive tab 30, connector 24, first contact 26, and second contact 28. Accordingly, the cell may be charged by introducing a recharging current or voltage to the cell. Advantageously, when internal pressure within the cell accumulates beyond a predetermined threshold, the grommet 22 flexes (reversibly) axially downstream along the direction of arrow A to bias the pressure-responsive from the first position illustrated in FIG. 2A to a second position illustrated in FIG. 2B. It should be appreciated that the predetermined threshold may depend on the intended type of charge being used (e.g. constant current, constant voltage, etc.), and may be determined by the material selected for the grommet, and thickness and flexibility of the arm 29.

Referring now to FIG. 2B, when the internal pressure within the cell exceeds the predetermined threshold sufficient to flex the grommet 22, the hub 27 is translated axially downstream, thereby also translating the first contact axially downstream with respect from the second contact 28, and removing the electrical connection therebetween. As a result, an electrical connection at the nubbin 20 will not transfer to the electrodes 14 within the cell, and further charging is prevented until the overpressure situation subsides.

Optionally, an insulating overpressure stop 32 can also be provided in an interior cavity defined by the nubbin 20. The overpressure stop 32 can also be used to pre-load the contact pressure as desired and can limit motion of the conductive connector 24 in the direction of the nubbin 20 when internal cell pressure is high. A stop washer 34 can also optionally be disposed between the second contact 28 and terminal end cap 18 to restrain the movement of the second contact when the grommet 22 flexes, thereby further insuring that the electrical connection will be severed between the two contacts during a high pressure state.

It should be appreciated that a plurality of cells could be installed in a battery pack and connected in series within a charger that is configured to supply a constant voltage or constant current charge to the cell. So long as at least one of the cells includes a pressure responsive switch in accordance with the invention (assuming pressure accumulates similarly within each cell), charging will terminate once the pressure within that cell activates the switch to remove electrical communication between the end cap 18 and electrode 14. Alternatively, each cell could include the switch such that the charging of all cells would terminate once one of the cells reaches a maximum permissible internal pressure. Alternatively, the cells could be connected in parallel to a charging source, in which case each cell would include a pressure responsive switch in accordance with the present invention.

FIGS. 2A-B also illustrate an optional a safety system for venting excess pressure (gas) from the cell when in an overpressure condition. In particular, the conductive connector 24 can define a centrally disposed pressure release channel 36 extending axially there through. Accordingly, gas produced at the electrodes is able to flow axially downstream from the cell interior 15 and through channel 36 to end cap interior 17. The end cap 18 also defines one or more outlets 35 extending there-through to enable the gas to flow from the end cap assembly 10 to the outside environment. The outlet can be secured against undesired leakage with a seal (not shown) adapted in tensile strength to yield at a pre-selected pressure level to release gas from the cell. The seal can be reversible or irreversible.

Alternatively, outlet(s) 35 may always be open to the environment, in which case a reversible airtight seal to the interior of the cell is maintained by blocking the pressure release channel 36. In particular, the overpressure stop 32 can also function as a overpressure release control if it is formed of a suitably deformable plastic material such as rubber for sealing pressure release channel 36 and outlet(s) 35 (if not open to the environment). In addition to the deformable material shown, other structures for releaseably blocking the pressure release channel include, without limitation, a plug or a spring. When the internal cell pressure rises to a sufficiently high level, the block is urged away from channel 36 and from outlet(s) 35 to define a pressure release path from the cell interior to the outside environment. The pressure at which the vent system releases the cell internal pressure depends on how much internal pressure a battery can withstand; the plastic material of the overpressure stop 32 is selected to respond to a pressure at which venting is desired, but to remain securely in place at lower pressures. Generally speaking, for a metal hydride rechargeable cell, the safety vent system responds to cell internal pressures between the pressure required to activate the switch and the pressure required to de-crimp the cell, for example greater than 400 psig and less than 2000 psig depending on the cell size. For instance, a size AAA cell can be configured to vent at a pressure between 1400 and 2000 psig, while a size AA, C, and Sub C cell can be configured to vent at a pressure between 400 and 1200 psig.

The opening and closing of the pressure release path through channel 36 and outlet(s) 35 can be reversible but may also be made irreversible by employing a block made of materials that do not revert to a shape or size or position that can effectively block the pressure release path after a first pressure rise. It will be appreciated that blocks other than those disclosed herein can be employed in both reversible and irreversible vent systems, as will be described in more detail below.

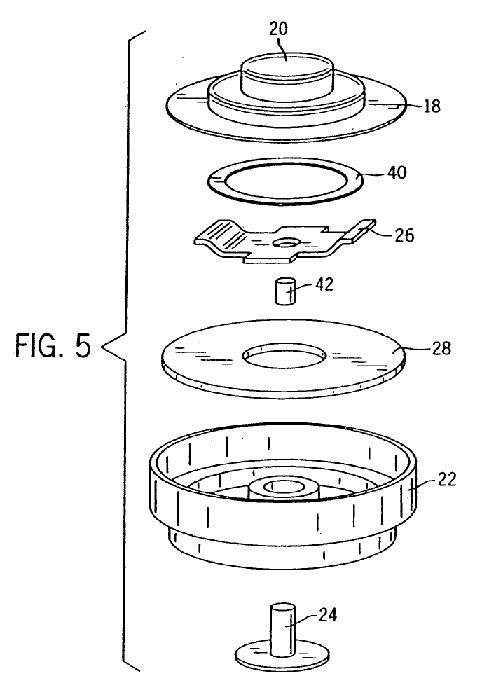

Referring now to FIG. 3, one example of an end cap assembly having an irreversible vent is illustrated, in which like elements to those illustrated in FIGS. 2A and 2B are identified by the same reference numerals. FIG. 5 illustrates these elements prior to being assembled into the can 12.

In accordance with this embodiment, the first contact 26 is not flat, but rather includes a flat central portion and four arms, each arm having a distal portion and a transition portion that connects the distal and central portions, which are not coplanar with each other. The central portion is in electrical contact with the conductive connector 24 and the second contact 28. The second contact 28 is electrically connected to end cap 18. Each distal portion of contact 26 is electrically isolated from the end cap 18 by an electrical isolator 40 that is disposed therebetween and aligned with the distal portion of contact 26.

When internal pressure builds up within the cell, grommet 22 flexes, thereby removing contact 26 from electrical communication with washer 28. The electrical connection between terminal end cap 18 and the electrodes is also thereby removed. Insulator 40 limits the permissible axial movement of contact 26, and further prevents electrical communication between the distal ends of contact 26 and the end cap 18. The first contact 26 thus responds well in concert with the grommet 22 to changes in the internal cell pressure, and is well-suited to urging reversion of the switch to the low pressure position when internal pressure subsides.

The venting system of FIGS. 3-5 is also configured somewhat differently than that of FIG. 2 in that the pressure release channel is plugged with an adhesively- or frictionally-engaged frustoconical plug 42 adapted to be irreversibly expelled from the channel at high internal cell pressures, for example between 400 and 1200 for a size AA, C, or sub C cell, and between 400 and 2000 psig for a size AAA cell. Referring to FIG. 4, the insulator 40 may extend radially from terminal end cap 18 to plug 42.

During operation, when the electrical connection is broken between electrical contacts 26 and 28, current flow drops to zero. This zero current flow can be detected by conventional charger circuitry (not shown) and can be interpreted as a signal that the cell is fully charged. The charger circuitry can then signal the end of charge condition. These circuits are considered to be conventional. More importantly, only complete current flow drop needs to be detected, rather than any more subtle change in pressure, voltage, temperature or rate of current flow as is typical in conventional metal hydride recharging systems.

The internal cell pressure at which the pressure-responsive switch is biased from the low pressure position to the high pressure position (the “biasing pressure”) can vary according to the size and shape of the battery, the charging rate and other charging conditions such as ambient temperature. For example, when the negative electrode of a battery has a much higher capacity than the positive electrode of the battery, the cell internal pressure at a low overcharge rate may be stabilized at a relatively low level such as 30-50 psig. Similarly, the higher the charge rate, the higher the cell internal pressure will be when a battery approaches the full charge state or reaches an overcharge state. Thus, when a switch is built for a battery having a much higher capacity at the negative electrode and/or when the battery will be charged at a very low rate, the biasing pressure of the pressure-responsive switch should be low enough to ensure that charge can be stopped when the battery reaches a full charge or overcharge state. On the contrary, when a switch is used in a battery that has similar negative electrode and positive electrode capacities, or when the battery will be charged at a high rate, the biasing pressure can be set at any level that satisfies battery safety concerns since there is no question that the cell internal pressure can reach the biasing pressure.

Preferably, however, a pressure-responsive switch should have a switch pressure that is close to the internal pressure when the cell reaches the full charge state, to prevent problems such as overheating. One of ordinary skill in the art knows how to determine cell internal pressure at the point of full charge or overcharge. Generally speaking, for a fast nickel metal hydride rechargeable cell, a pressure-responsive switch may have a biasing pressure of between about 50 psig and 500 psig. It is preferable that the switch pressure is less than the venting pressure, for example between 100 and 400 psig. In particular, it is preferable that the switch pressure is between 150 and 300 psig for a size AA, C, and sub C cell, and between 250 and 400 psig for a size AAA cell.

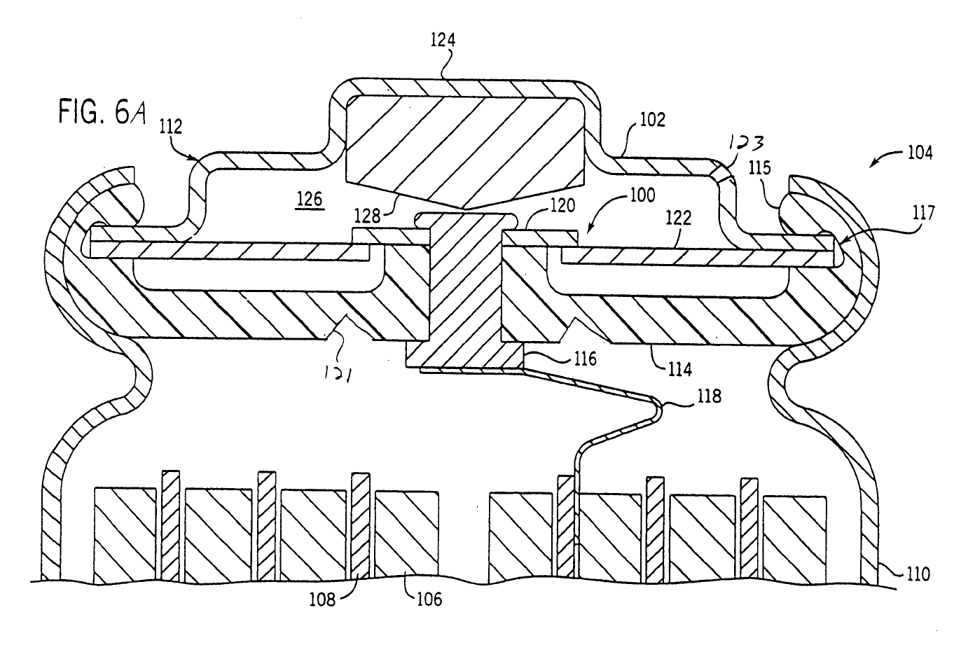

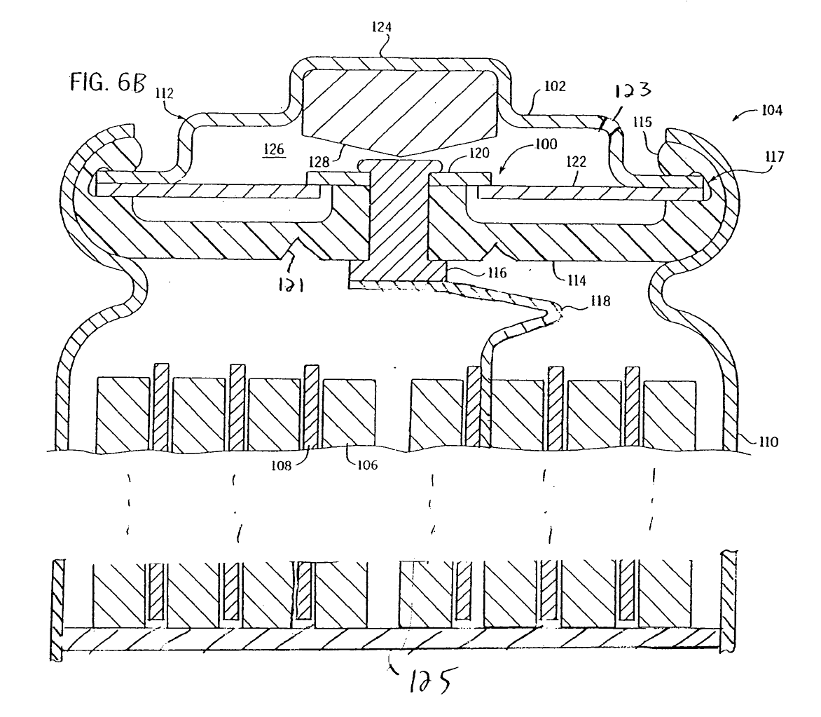

Referring now to FIG. 6A, a reversible pressure responsive switch 100 constructed in accordance with an alternate embodiment of the invention is disposed within a positive terminal cap 102 at the open end of a nickel rechargeable cell 104. The cell 104 may be conventional apart from the cap and its electrical connection to the cell electrodes. Cells made according to the present invention may comprise wound positive 106 and negative 108 electrodes in its interior, wherein the negative electrode (such as a hydride electrode) is in electrical connection with a can 110 having an open end and a closed end, and wherein the positive (e.g., nickel hydroxide) electrode is in electrical connection with the positive terminal cap 102 that is secured in the open end of the negative can 110. The cell contains an electrolyte, typically potassium hydroxide.

The open end of the cell 104 includes a cap assembly 112 constructed in accordance with the preferred embodiment, and disposed in the open end of the can 110. The open end of the negative can 110 is shaped to sealingly accommodate the cap assembly 112 in the open end during manufacture. The closed end of the cell can is not depicted but is conventional. The cap assembly 112 includes the positive terminal cap 102 and a pressure-responsive switch 100 constructed in accordance with the present invention.

The pressure-responsive switch 100 comprises a grommet 114 that provides both a flexible seal and main spring, and has a centrally disposed conductive connector 116, or “rivet” or “pin,” extending axially there-through. The grommet 114 may be formed of any material that does not negatively interact with the chemistry of the cell but which is sufficiently flexible to move in response to a pressure increase to bias the switch of the invention, as described above. The grommet 114 further includes an outwardly and upwardly extending lip 115 that is shaped and sized to form a tight seal with the open end of the can 110 to separate the interior of the cell from the exterior. The lip creates a radially inwardly facing void 117 that is occupied by end cap assembly components, as will be described in more detail below. In the illustrated embodiment, the lip 115 has a convex outer surface to accommodate a concave inner surface of the can 110 that allows the can to be crimped into position during cell assembly. An optional sealant such as asphalt or tar can also be employed between the cap assembly 112 and the can 110 to further seal the open end.

Toward the interior of the cell, a conductive tab 118 electrically connects the central conductive pin 116 to the positive electrode 106. Toward the exterior of the cell, the central pin 116 is also in electrical contact with a contact ring 120 which also serves to secure the central pin into its position. Contact ring 120 is a washer that surrounds the central pin 116 and, along with contact plate 122, is disposed in an internal cavity 126 that is defined by the positive terminal cap 102 and the flexible grommet 114. Contact ring 120 is thus in constant electrical communication with the central pin 116. Secured in the void 117 are a circular conductive contact plate 122 and the positive terminal cap 102 having a nubbin 124 sized and shaped to provide a standard positive terminal for the cell 104. The contact plate 122 is thus in electrical connection with both of the aforementioned positive end cap 102 and the contact ring 120 when the cell 104 is in the low-pressure state illustrated in FIG. 6A. Accordingly, the nubbin 124 is in electrical communication with the electrode 106 via end cap 102, contact plate 122, contact ring 120, central conductor 116, and tab 118.

In operation, the grommet 114 flexes outwardly in response to high internal cell pressure. When the internal cell pressure is sufficiently great to cause the grommet 114 to flex, the central pin 116 is urged toward the over-pressure stop 128, thereby biasing contact plate 120 axially away from contact plate 122 (not shown). The electrical connection between contact ring 120 and the contact plate 122 terminates, thereby terminating the electrical communication between the nubbin 124 and electrode 106. Further charging is thus prevented. Advantageously, the switch 100 is reversible, in that the connection between contact ring 120 and contact plate is reestablished once the overpressure situation subsides. Also provided on an inner surface of the positive terminal cap nubbin 124 in the cap assembly 112 cavity is a non-conductive over-pressure stop 128 which can also be used to pre-load the contact pressure as desired.

As described above, once the overpressure situation exists within the cell 104, the electrical contact is broken between contacts 120 and 122, current flow within the cell 104 drops to zero. This zero current flow can be detected by conventional charger circuitry and can be interpreted as a signal that the cell is fully charged. The charger circuitry can then signal the charge termination. These circuits are considered to be conventional. As was noted above, the rise in pressure, which follows gassing in the cell, precedes the damaging temperature rise that shortens cell cycle life.

Grommet 114 further includes a grommet arm having a necked-down section 121 that is designed to fail when the internal cell pressure reaches a venting pressure that is greater than the pressure required to flex the grommet outwardly as described above. Once section 121 fails, pressurized cell contents are able to exit the cell via an aperture 123 extending through positive terminal cap 102.

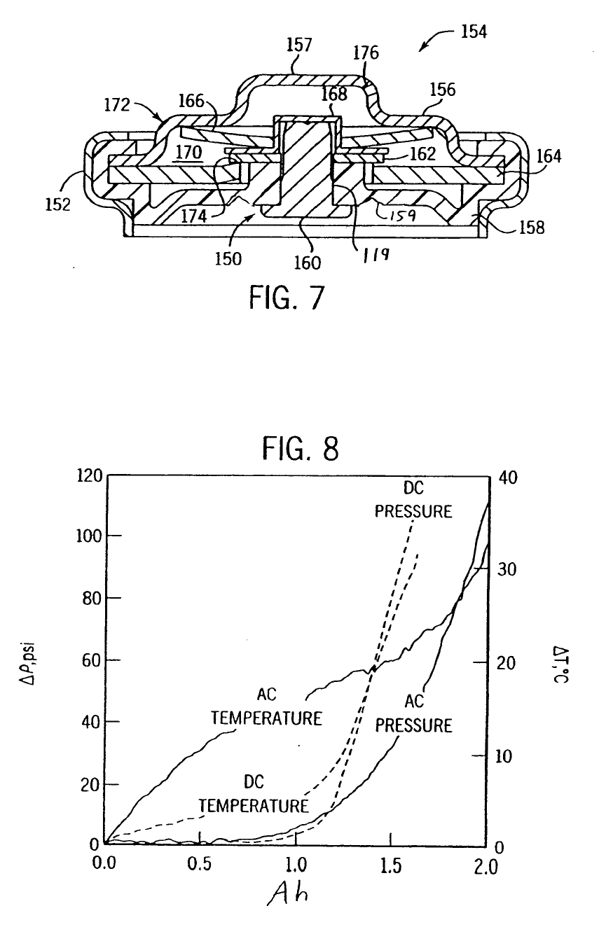

Referring now to FIG. 7, a reversible pressure-responsive switch 150 is illustrated in accordance with an alternate embodiment of the invention. In particular, cell 154 comprises a negative can 152 having an open end that is shaped to accommodate and seal the cap assembly 172 in the open end during manufacture. The remainder of the cell can is conventional. The cap assembly 172 includes the positive terminal cap 156 having a nubbin 157 that is sized and shaped to provide a positive terminal to the cell.

The regulating switch 150 illustrated in FIG. 7 includes a flexible grommet 158 adapted in size and shape to fit securely in the open end and having a central opening 119 there through. A conductive connector 160 is securely fixed in the central opening such that the conductive connector moves in concert with the flexible grommet 158. A first conductive contact 162 surrounds the connector 160 and is in constant electrical communication therewith. A second conductive contact 164 extends radially inwardly from the radially outer wall of grommet 158 such that at least a portion of its upper surface is axially aligned and in severable contact with the lower surface of contact 162.

Grommet 158 includes grommet arm, of the type described above, having a neck-down portion 159 that is operable to fail at a predetermined pressure greater than the pressure necessary to open the switch, but less than the pressure required to de-crimp the cell 154. A stop 166 is disposed axially downstream from contact 162, and limits the axial displacement of the grommet 158. Stop 166 is a bent annulus whose outer periphery includes a pair of locations that contact terminal cap 156. The remaining outer periphery of stop 166 enables pressurized cell content to flow into channel 176 when the necked-down section of grommet arm 159 fails. An insulating layer 168 is disposed between contact 162 and the stop 166. Accordingly, the stop 166 does not form part of the electrical circuit.

The grommet 158 may be formed of any sufficiently flexible, nonconductive inert material described herein that does not adversely impact the cell chemistry. Depending on the configuration of the switch elements, the switch 150 may be responsive to pressure, temperature, or both, as will become more apparent from the description below.

The terminal cap 156 and the flexible grommet 158 define a cavity 170 within the cap assembly 172 in which the first and second contacts 162 and 164, and stop 166 are provided. While the first and second contacts 162 and 164 are circular washers plates as illustrated in FIG. 7, they may be provided in other shapes and sizes, as described above. The second contact 164 includes three protrusions 174 proximal its radially inner edge that extend axially towards the first contact 162 and are radially spaced 120° from each other. When the internal pressure is less than a predetermined threshold, determined in large part by the flexibility of grommet 158, the protrusions 174 are in connection with the lower surface of the first contact 162, thereby completing the electrical circuit and permitting the cell to be charged.

Toward the interior of the cell, a conductive tab (not shown) electrically connects the central conductive pin 160 to the positive electrode in the manner described above. The hub of grommet 158 further serves to secure the central pin 160 in its proper position. Secured in the peripheral lip of the grommet 158 are the circular conductive contact plate 164 and positive terminal cap 156. The contact plate 164 is in electrical connection with both of the aforementioned positive end cap and the contact ring 162, although the latter connection is disconnected when the high temperature or pressure condition exists.

As described above, the end cap assembly 172 can also comprise a system for venting pressure from the cell. When the assembly comprises a vent system, the conductive connector 160 can define there through a pressure release channel for gas to flow from the cell interior on a first side of the flexible grommet 158 into the end cap assembly 172 on the second side similarly described in FIG. 3 and FIG. 4. The battery end cap 156 also defines one or more outlets 176 extending therethrough for gas to flow from the end cap assembly 172 to the outside environment. The vent mechanism can be reversible or irreversible. If the described vent system is not employed, other vent means can be provided.

In operation, the grommet 158, flexes (reversibly) axially downstream towards the positive end cap 156 and against the spring force of stop 166 in response to high internal cell pressure. The regulating switch 150 is thus biased from the closed position (illustrated in FIG. 7) to an open position (not shown), in which the central pin 160 moves axially downstream in concert with the grommet 158. Accordingly, the first electrical contact 162 becomes displaced from the second contact 164 and free from protrusion 174. The electrical contact between the contact ring 162 and the contact plate 164 is thus broken, and further charging is prevented, until the overpressure situation subsides and the grommet returns to the position illustrated in FIG. 7, and the electrical connection between contacts 162 and 164 is reestablished.

The stop 166 illustrated in FIG. 7 may further be manufactured from a temperature-responsive material that changes shape when a predefined temperature is attained. In this way, a stop can be fashioned to reversibly deflect or deform at a certain internal cell temperature, thereby reducing or removing the preload force on the central pin and reducing the pressure required to break electrical contact between the contact ring and the contact plate. In this way, a potentially harmful temperature rise is prevented, even if no overpressure condition exists within the cell. In operation, when the cell reaches a predefined temperature, the stop 166 can reversibly deflect or deform and pull the conductive connector 162 away from the contact plate 164, thus breaking electrical contact between the contact ring and the contact plate. Alternatively, the stop 166 can be connected to the conductive connector or central pin 160 and the terminal cap 156.

While any temperature-responsive material can be used, the stop is preferably formed from a bimetal composed of two layers of metals or alloys or other materials with different coefficients of thermal expansion. One layer has a higher thermal expansion and the other layer has a lower thermal expansion. This causes the bimetal to deflect or deform in response to temperature in a way that can be defined by the choice of metals or alloys used in each layer. Alternatively, a shape memory material can be used to form the temperature-responsive stop 166, such as a nickel-titanium alloy.

The temperature-responsive stop 166 can additionally operate as a pressure-responsive stop. Shape memory materials include alloys of Nickel-Titanium, Copper-Zinc-Aluminum, or Copper-Aluminum-Nickel. These materials are pre-formed to the concave disc shape 166 as shown to act as the spring and to apply a pre-determined amount force that will hold the conductive contact 162 and contact plate 164 together for electrical continuity. These materials have the ability to deform and flatten out when heated to a pre-determined temperature or become flatten out also when internal pressure reaches a pre-determined value. It has been found that the most desirable temperature range for these materials to work with nickel-metal hydride or nickel-cadmium cells is between 70 deg C. and 100 deg C.

It should be further appreciated that the stops illustrated in accordance with any of the previous embodiments may also be constructed to be responsive to temperature and/or pressure.

As described above, the charger may conclude that charging has terminated based on a zero current flow within the cell, or when charging time has reached a predetermined value. The charger may then either discontinue the charge, or it could continue charging, in which case the pressure responsive switch will continue to open and close. The charging would therefore continue until a timer reaches a termination point at a pre-set value. This charging mode can be particularly advantageous when charging at a rate faster than 30 minutes, where pressure increases significantly when the cell is approaching a fully charge state, and the on-off of current provided by the pressure switching mechanism will continue to top up the charge to the maximum charge state. If the cell is being charged under constant voltage, constant current or alternating current at a very charge fast rate (charge termination within 30 minutes or less) the cell may be only charged to approximately 70-90%, as it is known that internal cell pressure increases ahead of a full cell charge during charging. The present inventors have determined that a constant voltage charge is more advantageous than a constant current or alternating when achieving a very fast charge rate (charge termination in 30 minutes or less), because charge current continues to decrease toward the end of charge with constant voltage, and as the result, pressure and temperature are not rising as quick in comparison to charging with a constant current. For example, up to 85-90% of charge can be achieved with constant voltage before the opening of the switch in comparison to 80-85% with alternating current and 65-70% with constant current. In some instances, the fast charging accomplished using the switch presented in accordance with the present invention offsets the disadvantage associated with the partial charging of the cell.

In other instances, it may be desirable to sacrifice time to ensure that the cell has become fully charged. In this instance, once the charger detects a zero-current, it waits until the internal pressure within the cell subsides and then measures the OCV for the cell (a pressure release vent would be particularly advantageous in such cells to minimize the cell depressurization time). Based on the OCV, the charger may determine whether the cell has been fully charged.

For example, it is known that a fully charged metal hydride cell will have an OCV of 1.42 V. Accordingly, if the OCV of the cell that is being charged has exceeded a predetermined threshold of 1.42-1.48V, the charger would determine that the cell is fully charged. Otherwise, the charger will conclude that the cell has not yet been fully charged. Accordingly, once pressure within the cell has dissipated such that the electrical connection between contacts is established, the charger will again subject the cell to the alternating or constant current charge until the internal pressure within the cell breaks the electrical connection. This iterative process may continue until the cell reaches a predetermined OCV or a predetermined number of iterations, at which point the charger will provide an appropriate message to the user, for example by illuminating an indicator. Alternatively, the user could select a charge termination (e.g., 80% capacity), at which point the charger would calculate the corresponding OCV and terminate charging when the cell has reached the user-selected charge termination threshold.

This process would be more desirable when using constant current or alternating current charging, as pressure is known to build up significantly before the cell is fully charged. If a constant voltage charge is applied to the cell, it would be expected that the cell would be substantially fully charged after the first iteration, thereby allowing the charger to detect a zero current and indicate that the cell is fully charged. While the zero current flow method described above could also be used in combination with constant current and alternating current charging, the cell may not be fully charged when the first iteration terminates.

One advantage of the reversible switches illustrated and described in accordance with the present invention is that detection of charge termination is not dependent on oxygen recombination. Therefore, there is no longer any need to provide excess negative electrode capacity. Oxygen at the positive electrode and hydrogen at the negative electrode can be evolved. Both gasses contribute to the pressure. In this case, the negative electrode capacity can be made equal to the positive electrode capacity, for a net increase in cell capacity. When charging current stops, oxygen recombines with hydrogen to form water:

½O₂+H₂→H₂O.

Another advantage is that a non gas-permeable separator may be used. This eliminates the needs for having open flow channels within the separator for the gas to be recombined with negative electrode, which had contributed to separator dry out and limited cell cycle life. With the pressure-responsive switch of the invention, additional electrolyte can fill in the channels. Therefore, cycle life and discharge efficiency would be increased.

Another advantage is that sophisticated analytical circuitry is not employed for detecting an end-of-charge condition, thereby reducing the cost of an associated charger device.

Another advantage is that charging can proceed at a faster rate than in prior cells. For example, a rechargeable metal hydride battery according to the invention can be charged in 45 minutes or less, preferably in 30 minutes or less, and most preferably in 20 minutes or less, even 10 to 15 minutes for a NiMH 1.3 Ah AA cell, whereas conventional cells require about 1 hour or more to charge (1.2C). The charging rate can be accelerated because the invention eliminates the concerns about overpressure and high temperature conditions at the end of charging. In this regard, fast charging may be achieved at rate less than an hour.

Another advantage is that a cell of the present invention can have a higher capacity than a conventional rechargeable metal hydride battery. This is because a cell constructed in accordance with the present invention can have a greater balance of negative electrode material to positive electrode material. Unlike prior art cells, in which the negative electrode has an excess capacity of greater by 40-50% more than the positive electrode, a cell of the present invention can have a ratio of anywhere between 0.9:1-1.5:1 by weight of negative electrode material to positive electrode material in accordance with the preferred embodiment.

Another advantage is that a gas impermeable separator may be implemented, which may be manufactured thinner and denser than the prior art, leaving more room for electrolyte within the cell. Cycle life is thereby increased, as is discharge efficiency.

In particular, oxygen at the positive electrode and hydrogen at the negative electrode can be evolved during charging. Both gasses contribute to the pressure. In this case, the negative electrode capacity can be made equal to the positive electrode capacity, for a net increase in cell capacity. When charging current stops, oxygen recombines with hydrogen to form water: ½O₂+H₂→H₂O. Because, in such an embodiment, the separator may be gas impermeable, the limitation on electrolyte filling for preventing the separator to be totally saturated in prior art cells is eliminated.

Furthermore, whereas the positive electrode of prior art rechargeable metal hydride cells typically comprise type AB5 alloys, it also possible to employ the higher-capacity AB2 alloys that have traditionally been disfavored in such cells because of overpressure concerns.

The present invention further includes a method of charging a cell or a plurality of cells that contain the pressure-responsive switch of the present invention. The method comprises the steps of connecting the cell(s) to a power source, such as a dedicated charger, charging the cell(s) until the cell internal pressure reaches a predetermined level whereupon the switch is biased to the high-pressure position and the charging circuit is interrupted. When the charging circuit is interrupted, the drop in charging current to zero can be manually or automatically noted. A charger used to charge the battery can include circuitry for detecting zero charging current or a timer set to a pre-determined value for terminating, and an indicator for displaying that the charge has terminated. Alternatively, as described above, the charger could undergo a plurality of charging iterations to provide a full charge to the cell.

While any type of method may be used to charge a cell incorporating a reversible switch in accordance with the present invention, a constant voltage charging method is preferred, since the current is allowed to seek its own decreasing level as charging proceeds without concern that the cell will be subject to overcharging or overpressure. With constant applied voltage charge method, as the cell voltage increases during charge, the current is automatically reduced toward the end of charge. Accordingly, the charging current is high at the beginning of charging when the cell's charge acceptance is high, and tapers to a lower charge current toward end of charge when the cell's charge acceptance is reduced. No expensive and complicated charging control is necessary. The current flowing into the cell is regulated by the cell internal resistance and the cell's own state of charge. When the cell reaches full charge, the increasing internal pressure will activate the pressure switch to interrupt charging. Accordingly, when the charger indicates that the charging has terminated, the cell will be at or near full charge.

Advantageously, strings of cells in parallel can be charged with the same voltage source. Multiple cells in series may also be charged together in accordance with the present invention by receiving the charging voltage that is equal to the open circuit voltage of the cell plus the over-voltage caused by cell internal resistance and the predisposed resistance of the circuit. Advantageously, with constant voltage charge, an even faster charge rate than that of constant current charge can be reached due to the ability to increase the charging current at the beginning of the charge when the cell can accept higher currents.

It should be appreciated, however, that the present invention is equally applicable to constant current and alternating current charges. As described above, it is known that the pressure inside metal hydride cells rises rapidly when cell charging is essentially complete. As was noted above, the rise in pressure, which follows gassing in the cell, precedes the damaging temperature rise that may shorten cell cycle life. Thus it is desired to terminate charging when the pressure begins to rise and prior to onset of a destructive overpressure condition.

### EXAMPLES

For a nickel metal hydride cell to be charged in 15 minutes or less, the preferred constant charging voltage is about 1.6V to 1.65V for a AA cell with 30-40 mOhm internal resistance determined by voltage difference between cell OCV cell voltage at 6 seconds interval at 10 amperes current. For cell with lower internal resistance (C-size cells, for example, having internal resistance of 10-20 mOhms), charging voltage lower than 1.6V but higher than 1.5V can be applied. The inventors have determined empirically that constant voltage charging is preferred when the ambient temperature is above freezing while constant current charging is preferred when the ambient temperature is below freezing.

Commercial AA and AAA nickel metal hydride cells containing a pressure-responsive switch in the end cap assembly were fully charged in 15 to 30 minutes and charging was terminated when the pressure-responsive switch was biased into the high pressure condition. The pressure signal was consistent and reproducible even with extended cycling. Constant voltage charging method was shown to be more favorable when ambient temperature is above freezing. Constant current method is more effective when ambient temperature is below freezing. The slope of pressure rise and fall of AA NiMH consumer cells remained relatively constant during the course of cycling. The current-tapering effect when using constant voltage resulted in a lower pressure rise over time for the cell to become fully charged. The drop in current also produced lower temperature rise for the same charging period. Charging was demonstrated to be faster at higher voltages, although a higher cell temperature was also noted under such conditions.

As described above, it is known that the pressure inside metal hydride cells rises rapidly when cell charging is essentially complete. In particular, the rise in pressure, which follows gassing in the cell, precedes the damaging temperature rise that shortens cell cycle life. Thus it is desired to charge the cells in a manner that reduces the possibility of a destructive overpressure or overheating condition.

A constant current charging method or a constant voltage charging method or a combination method, for example, constant current followed by constant voltage, can be employed in accordance with the present invention. An alternating current charging method can be preferred, since the current is modulated, thus reducing the chance of overcharging, overpressure or overheating. No expensive and complicated charging control electronic circuitry is necessary.

The nature of the alternating current or voltage waveform is typically, but not exclusively, sinusoidal. Full or half wave rectification may be applied to the alternating current or voltage waveform.

FIG. 8 illustrates the cell pressure and temperature for a 1600 mAh nickel metal hydride cell charged using an alternating current derived from common 60 Hz line power that was full wave rectified to yield a 120 Hz alternating current frequency. The change in cell pressure and temperature are lower at the end of charge compared with a constant, or direct, current charge.

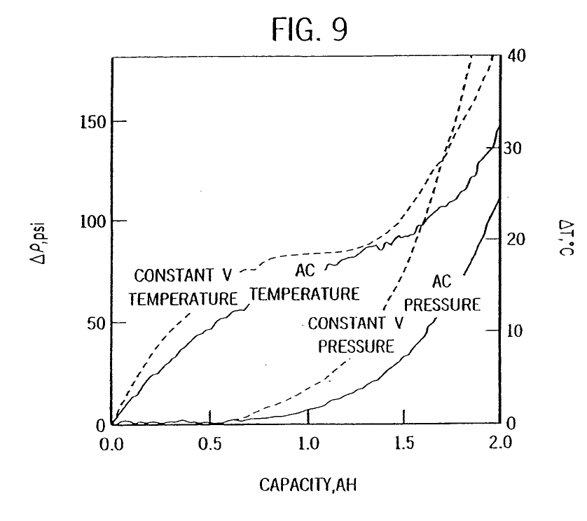

FIG. 9 shows the cell pressure and temperature for a 1600 mAh nickel metal hydride cell charged using an alternating current as in FIG. 8. The change in cell pressure and temperature are lower at the end of charge compared with a constant, or direct, voltage charge.

The examples illustrated herein utilize a full wave rectified current derived from common 60 Hz line power. Other embodiments encompassed by the present disclosure include full wave rectified alternating voltage or half wave rectified sinusoidal alternating current or voltage. Another embodiment is an alternating current or voltage charge of any frequency. Another embodiment is an alternating current or voltage comprised of any waveform, including square wave, triangle wave (or sawtooth wave), or any arbitrary waveform or combination of waveforms. Another embodiment is the combination of rectified and unrectified alternating current or voltage composed of any frequency or combination of frequencies, or any waveform or combination of waveforms. Advantageously, any of these charging methods may be utilized by a cell having a pressure-responsive switch as described above.

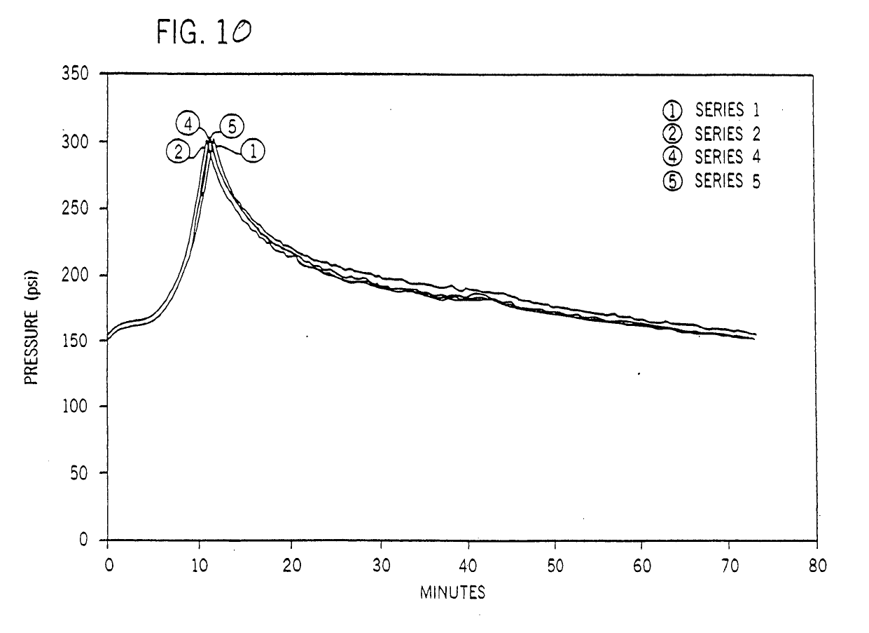

Referring now to FIG. 10, cell internal pressure vs. time is illustrated for a group of four 1600 mAh Nickel Metal hydride cells being charged with a constant voltage at 1.65V. The internal pressure rises to 300 psig as the cells reach full charge in 12 minutes. The pressure returns to the initial state following discharge of the cells. This demonstrates that the internal pressure of Nickel Metal Hydride cell rises and falls in a predictable manner, which can be used as a reliable signal to terminate charging of a high rate. Groups of cells can thus be charged and discharged reliably when pressure is used as a charge termination signal.

Referring now to FIG. 11, typical charging and discharging characteristics of a 1300 mAh NiMH cell were measured under a constant current charge of 3A followed by a 1A discharge to 1V. The pressure, temperature, and voltage were measured, and plotted vs. time. This illustrates that pressure is a much stronger signal for charge termination than temperature and voltage. Pressure rises at much faster rate than temperature and voltage, therefore pressure is a more suitable signal than temperature and voltage for charge termination.

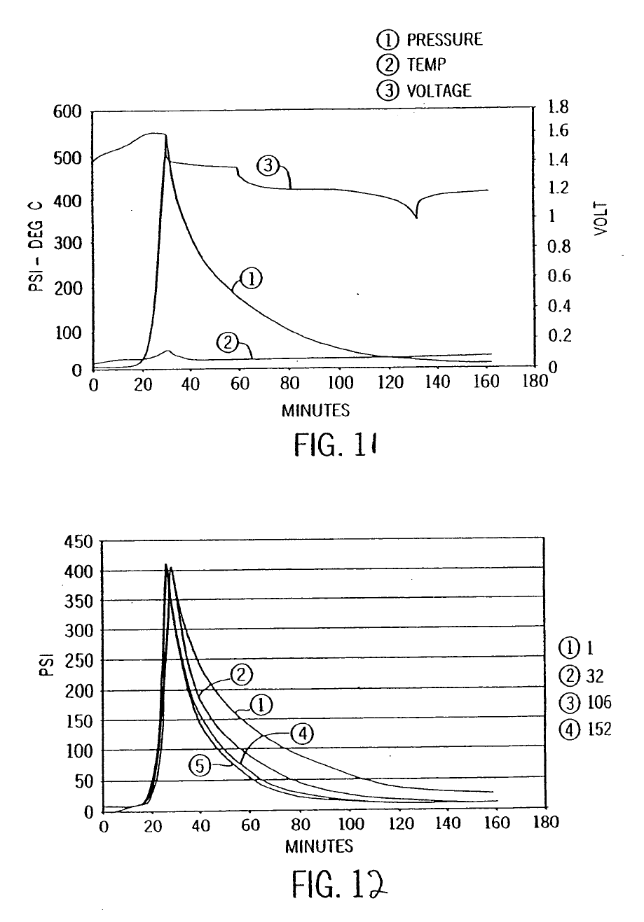

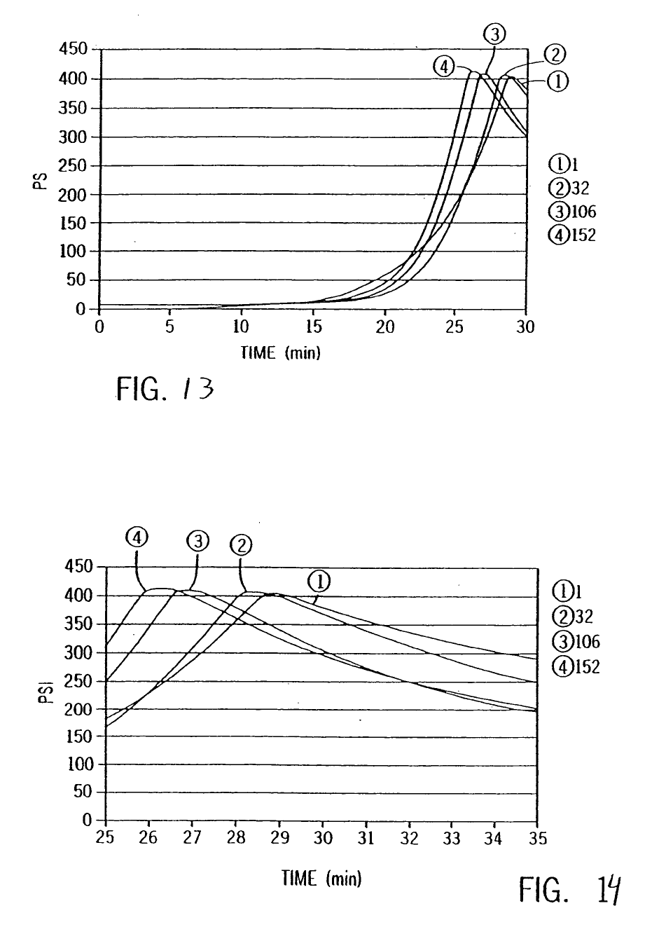

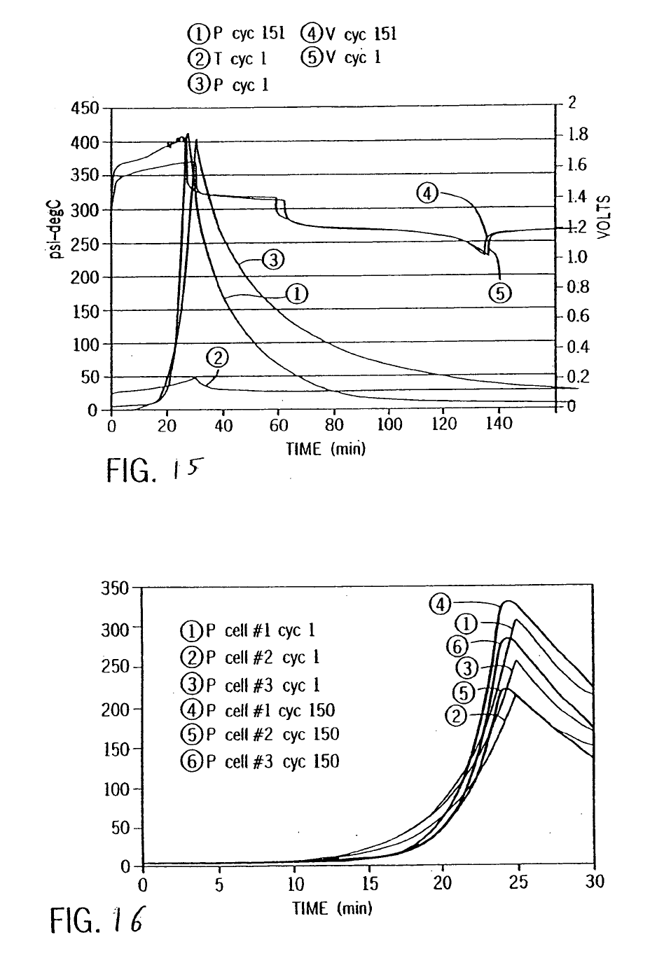

Referring now to FIG. 12-21, the slope of pressure rise and fall remained relatively constant during the course of cycling in comparison to the voltage illustrated in FIG. 15. This further indicates the reliability of pressure as an indicia for the charge termination point of a cell.

Referring to FIG. 16, three 1600 mAh Nickel Metal hydride cells were subjected to a 3.7A constant current charge and discharge for 150 cycles. The internal pressure of the cells was shown at cycle 1, and at cycle 150, and plotted vs. time. This further illustrated that pressure signal is reproducible with cycle life and different cell size and capacity.

Referring to FIG. 17, two even smaller 550 mAh Nickel metal hydride cells were connected in series and charged with a constant voltage charge source at 1.65 V per cell. The internal pressure, temperature, and Amperage were measured and plotted vs. time.

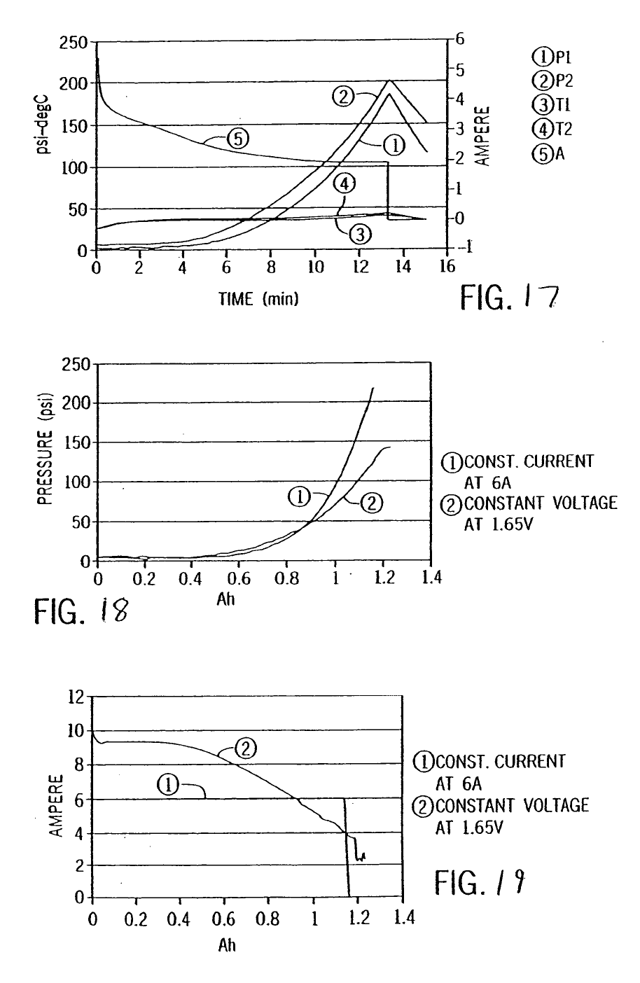

FIG. 18 illustrates internal cell pressure as a function of capacity for a first cell charged under a constant current at 6A, and a second cell charged under constant voltage at 1.65V. FIG. 19 illustrates cell current as a function of capacity for the first and second cells. FIG. 20 illustrates internal cell temperature as a function of capacity for the first and second cells. FIG. 21 illustrates cell voltage as a function of capacity for the first and second cells. As illustrated, one significant advantage of constant voltage over constant current is the ability of charging current to taper towards then end of the charge as cell voltage rises closer to the applied voltage. The tapering effect results in a lower pressure rise and lower temperature rise at end of charge, thereby allowing the cell to become more fully charged. The drop in current also produces a net lower temperature rises for the same charging period.

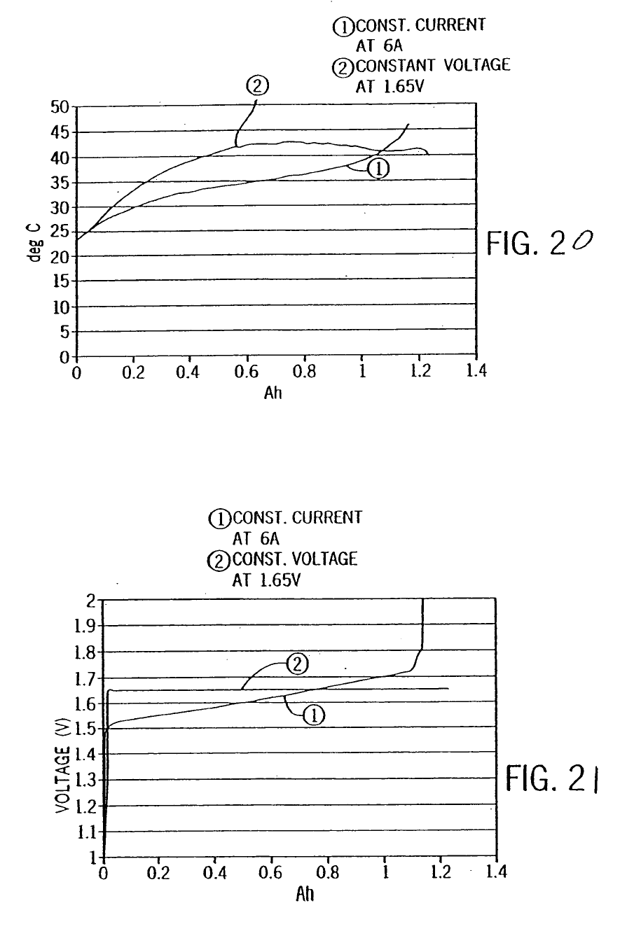

Referring now to FIG. 22, cell temperature and charge input capacity are plotted as a function of time for two cells charged under two different voltage conditions. It may be observed that a higher charge voltage produces a higher charge current for a cell having the same internal resistance. Accordingly, charging is quicker at higher voltage, but the cell is also hotter at higher charge voltage. This figure further illustrates that at higher charge voltages, the cell reaches higher charge state sooner. This also shows that as the pressure activated switch opens in case of the higher charge voltage cell, cell temperature drops as the result of switch on-off condition. Cell continues to accept charge at this state but at lower temperature under intermittent current condition provided by the pressure switch. This is an advantage for having a pressure switch as a means for regulating end of charge condition.

As described above, it is preferable in accordance with one embodiment of the invention to provide a constant voltage charge less than or equal to approximately 1.6-1.65 V during fast charging, though the present invention contemplates that any constant voltage charge between 1.2 and 2 V is contemplated by the present invention.

For instance, the present invention recognizes that, in some instances, it may be desirable to initiate a controlled voltage charge at a level greater than 1.65 V. While 1.65 V is used as an example, it should be appreciated that this level can be any voltage level between 1.2 and 2.0 V, including those levels that fall in the range of 1.2 and 2.0 V in 0.05 V increments. It should be appreciated that these benchmarks are approximate, and include voltage deviations of +/−0.05 V from the benchmark. In accordance with this embodiment, the constant voltage is stepped down as a function of one or more measurable variables such as duration of charge, charge current, cell temperature, cell resistance, or cell voltage. Advantageously, the cells are exposed to a greater initial charge and, as the cell nears the charge termination point that will open the pressure responsive switch, the cell is receiving a charge equal to, or less than, 1.65 volts.

For instance, one embodiment envisions charging the cell initially at 1.75 volts (only as an example), and decreasing the charge voltage by a predetermined amount in response to increases in cell temperature. The voltage decreases can be continuous, and not time dependent, thus producing variable voltage having a negatively sloped voltage curve. The curve can be constant or linear, depending on the rate of cell temperature change. Alternatively, the decreases can take place after a predetermined period of time, thereby producing a plurality of stepped constant voltages, wherein subsequent steps are of a less charge voltage than the previous step. In accordance with the preferred embodiment, the voltage decreases anywhere between 0.5% and 5% (preferably between 2% and 4%) for each degree C. of cell temperature increase, which can be obtained using a thermistor placed proximal the cell. Once the applied charge voltage is equal to a predetermined base voltage, for example 1.65, the charge voltage will maintain constant until either an excessive temperature (e.g. approximately 50 C) is measured, or a predetermined length of time expires (for example less than 15 minutes), it being appreciated that the pressure responsive switch will also regulate the cell charging.

Accordingly, the cell will become fully charged during the charge cycle. It should be appreciated that, while 1.65 V is used as a benchmark in accordance with the above example, it should be appreciated that the benchmark can be any voltage level between 1.2 and 2.0 V, including those levels that fall in the range of 1.2 and 2.0 V in 0.05 V increments.

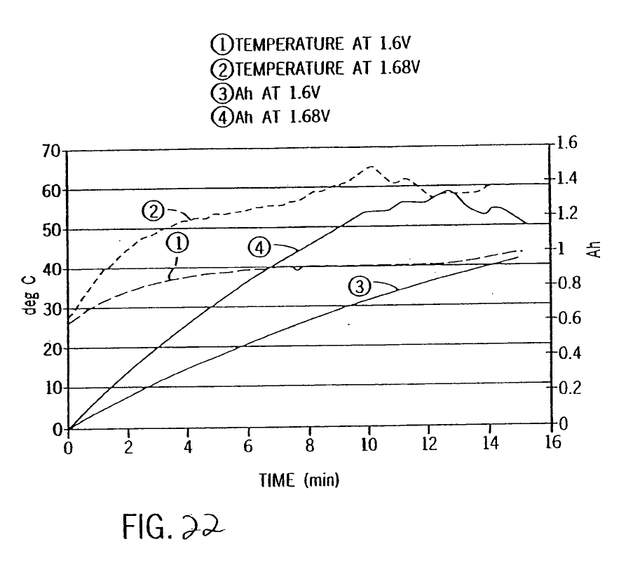

Referring now to FIG. 23, an axially extending cell constructed in accordance with another alternate embodiment of the invention includes a can 312 having closed end (not shown) and an open end 313 disposed opposite the open end and axially downstream therefrom. A cap assembly 310 includes a positive terminal end cap 318 that is secured in the open end of the negative can 312 to provide closure to the cell. In particular, the end cap assembly 310 and the open end of the can 312 are adapted in size and shape such that the end cap assembly 310 is sealingly accommodated in the open end by crimping the negative can 312 during assembly of a cylindrical rechargeable metal hydride cell. The closed end of the can is conventional and is not shown.

A positive (e.g., nickel hydroxide) electrode 314 is in removable electrical connection with the positive terminal cap 318, as will become more apparent from the description below. The cell further contains a negative electrode 321 (e.g., hydride electrode) that is in electrical connection with the can 312, and an alkaline electrolyte (e.g., potassium hydroxide) alone or in combination with other alkali metal hydroxides. The electrodes are disposed in an internal cavity 341, and are separated by a separator 316. A cell comprising the can 312 and the end cap assembly 310 of the invention can further comprise conventional positive 314 and negative 321 wound electrodes in its interior, although the relative size of these electrodes can be adjusted to meet the physical and electrical specifications of the cell.

The positive terminal cap 318 has a nubbin 320 that is sized and shaped to provide a positive terminal to the cell having a pressure-responsive switch 311 constructed in accordance with the present invention. The pressure-responsive switch 311 comprises a flexible non-conductive mono-stable member in the form of grommet 322 adapted in size and shape to fit securely in the open end 313. Grommet 322 includes a radially outer seal 325, an inner hub 327, and an arm 329 that extends substantially radially and connects the seal to the hub. Grommet 322 further includes a centrally disposed opening 315 extending axially through the hub 327 in which is seated a conductive connector in the form of eyelet 324 having a pair of oppositely disposed radially extending outer flanges 323. The space between the outer surface of grommet 322 and inner surface of terminal end cap 318 defines a cavity 317 in the end cap assembly 310. Arm 329 extends radially through the cell, thereby reducing the volume of cavity 317 compared to cells whose arm extends radially and axially towards the negative end. The internal volume available for active cell components of cell 310 is also therefore increased to correspondingly increase the cell capacity. In accordance with this embodiment, the distance between the upper surface of the nubbin 320 to the lower surface of the grommet 322 is approximately 3.8 mm, thereby leaving the remaining cell height for the electrodes.

Connector 324 is securely fixed in the opening of grommet 322 such that the conductive connector moves in concert with the grommet. A first annular conductive contact 326, which is a metal washer in accordance with the illustrated embodiment, surrounds the hub of connector 324 and has an upper surface in electrical contact with the upper flange 323. A second annular conductive contact 328 (which can also be a metal washer) surrounds the grommet and is positioned axially upstream and adjacent the first contact 326. The first and second contacts 326, 328 are cylindrical plates in FIG. 23 but they can be provided in other shapes, as described above. A spring member 334 is disposed between the upper surface of grommet arm 29 and the lower surface of contact 328 so as to bias contact 328 outwardly such that upper surface 351 of contact 328 is in electrical connection with the terminal cap 318, and in removable mechanical (and therefore electrical) connection with the bottom surface of the first contact 326, as will become more apparent from the description below. Spring member 334 is preferably nonconductive.

As described above, grommet 322 can be formed of any sufficiently flexible, nonconductive inert material that does not adversely impact the cell chemistry.

The outer seal 325 of grommet 322 includes an upwardly and radially inwardly extending peripheral lip 338 that is shaped and sized to form a tight seal with the open end of the can to provide a barrier between the interior and the exterior of the cell. The lip 338 also partially defines a cavity in the outer seal 325 in which the outer end of terminal end cap 318 and second contact 328 are disposed. The lip 338 presents a radially outer convex surface to permit the can 312 to be crimped over the grommet 322 during assembly of the cell. When the axially downstream end of can 312 is crimped over the grommet 322 during assembly, a tight seal is provided between the grommet 322, second contact 328, and terminal end cap 318 to isolate the interior of the cell from the ambient environment. An optional sealant such as asphalt or tar can also be employed between the end cap assembly 310 and the can 312 to strengthen the seal.

A flexible conductive tab 330 electrically connects the conductive connector 324 to the positive electrode 314 in the interior of the cell. The conductive connector 324 can be an eyelet or rivet that is secured in the central opening by crimping at its ends to provide flanges 323 that secure the hub 327 of grommet 322 and the first contact 326. The conductive connector 324 is in electrical and physical contact with the first contact 326 thereby helping to secure the conductive connector 324 into position.

FIG. 23 illustrates the end cap assembly in a low pressure state, such that the grommet 322 is in its stable position. In this low pressure state, the positive electrodes 314 are in electrical connection with the positive terminal cap 318 via the conductive tab 330, connector 324, first contact 326, and second contact 328. Accordingly, the cell may be charged by introducing a recharging current or voltage to the cell. Advantageously, when internal pressure within the cell accumulates beyond a predetermined threshold, the grommet 322 flexes (reversibly) axially downstream along the direction of arrow B to bias the pressure-responsive from the first closed position illustrated in FIG. 23 to a second open position. It should be appreciated that the predetermined threshold may depend on the intended type of charge being used (e.g. constant current, constant voltage, etc.), and may be determined by the material selected for the grommet, and thickness and flexibility of the arm 329.

When the internal pressure within the cell exceeds the predetermined threshold sufficient to flex the grommet 322, the hub 327 is translated axially downstream, thereby also translating the first contact 326 axially downstream with respect from the second contact 328, and removing the electrical connection therebetween. As a result, an electrical connection at the nubbin 320 will not transfer to the electrodes 314 within the cell, and further charging is prevented until the overpressure situation subsides.

FIG. 23 also illustrates an optional safety system for venting excess pressure (gas) from the cell when in an overpressure condition. In particular, the conductive connector 324 can define a centrally disposed pressure release channel 343 extending axially there through. A plug 345, preferably made of a rubber or other suitably compliant material, is disposed in channel 343 and provides a seal to prevent pressurized gas from flowing through the channel 343. Accordingly, as gas is produced at the electrodes, pressure accumulates within the cell interior 341. Once the pressure reaches a predetermined maximum threshold, plug is biased axially downstream along the direction of Arrow B and into end cap interior 317. As the plug 345 will not reseal channel 343, the venting mechanism illustrated in FIG. 23 is irreversible. The end cap 318 defines one or more outlets 355 extending there-through to enable the gas to flow from the end cap assembly 310 to the outside environment. The outlet 355 can be secured against undesired leakage with a seal (not shown) adapted in tensile strength to yield at a pre-selected pressure level to release gas from the cell. The seal can be reversible or irreversible. Alternatively, as illustrated, outlet(s) 355 may always be open to the environment, in which case an airtight seal to the interior of the cell is maintained by blocking the pressure release channel 343 during normal operation.

Referring now to FIG. 24, cell 310 is illustrated having pressure responsive switch 311 as illustrated in FIG. 23, but with a different venting structure. In particular, plug 345 includes a neck 353 that extends axially through channel 343, and defines an internal axially extending channel 359. A transverse arm 357 is disposed at the axially outer end of plug 345, and provides a seal to channel to prevent gas from escaping into chamber 317 during normal operation. If the internal cell pressure reaches a predetermined threshold, however, arm 357 will rupture, thereby enabling the pressurized gas to exit the cell via channel 359 and aperture 355. Because arm 357 ruptures during operation, the venting apparatus is irreversible.

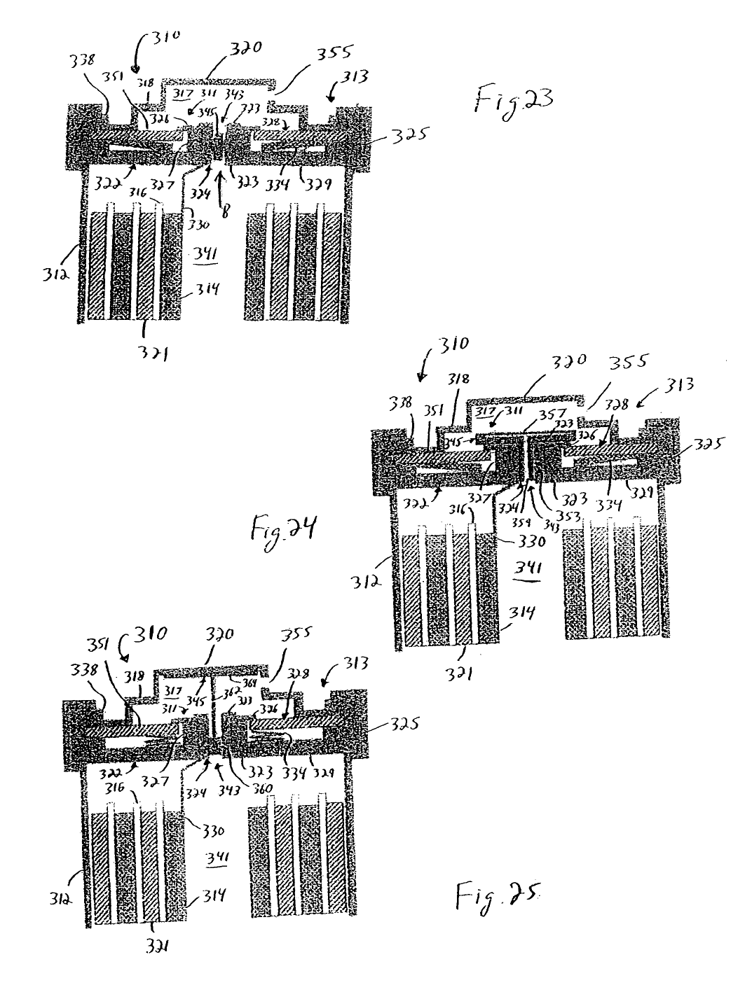

Referring now to FIG. 25, cell 310 is illustrated having pressure responsive switch 311 as illustrated in FIGS. 23 and 24, but with a different venting structure. In particular, plug 345 includes a seal member 360 that is disposed within channel 343 and prevents pressurized gas from flowing into chamber 317. Seal member 360 is connected via axially extending arm 362 to a base plate 364 that abuts the inner surface of nubbin 320. Accordingly, when the internal pressure reaches a predetermined threshold to displace grommet 322 to open the electrical contact between members 326 and 328 as described above, seal member 360 is displaced axially upstream with respect to grommet 322 and eyelet 324. Once seal member 360 is clear of the lower surface of eyelet 324, pressurized gas is able to flow through channel 343 and exit the cell via aperture 355. If the vent plug base plate 364 merely abuts the nubbin 320, but is not attached to nubbin 320, the plug will collapse within the cell during venting, thereby rendering the plug unusable for future use. However, base plate 364 may alternatively adhere to the inner surface of nubbin 320, in which case the structural integrity of plug 345 would be maintained during venting, thereby rendering plug 345 reversible.

The present invention recognizes that high voltages (generally within the range of 1.2 and 2 V for AAA, AA, C, and C cells) and currents (generally within the range of 4 and 15 Amps for size AAA and AA cells) are typically required when fast charging secondary size AA and AAA cells.

The result is that the cell is charged at a rate anywhere between 2C and 50C, depending on the cell size. For instance, using the present invention, a 2000 mAh AA cell can be charged at 3-5C, and preferably 4C, and an 800 mAh AAA cell can be charged at 57C, and preferably 6C. It should be appreciated that size C and D cells that include a pressure switch constructed in accordance with any of the embodiments described herein can be charged using proportionately higher charge currents than AA and AAA cells to generate comparable C rates. For example, a 3500 mAh C size cell can be charged at a C rate between 3-5C, and preferably 4C using currents between 10 and 30 A.

Fast charging produces heat within the cell, thereby increasing cell temperature during charging. Excessive temperatures have been found to damage conventional cell components. Accordingly, the development of larger cells that can be fast charged has been limited by the temperatures that the cells can withstand. Many conventional high power applications would benefit from larger rechargeable cells, such as sub C size cells that can be used in, for example, power tools and the like.

Several battery systems are currently competing for dominance in electric vehicles, including lead acid, nickel cadmium (NiCd), lithium ion, zinc air and nickel metal hydride (NiMH). To be acceptable to the driving public, it is desirable to minimize the time required to charge the batteries, perhaps no more time than is required to fuel existing vehicles with gasoline. This is an important challenge that has historically limited the acceptance of an electric vehicle battery system.

As described above, an electrochemical cell, especially NiMH, including a pressure switch that limits overcharge can be charged at constant voltage. The combination of the pressure switch and the constant voltage method of charging permits the cell to be charged at high rates. This decreases the time required to charge a cell, which is a large advantage for a variety of applications and devices.

For example, large cells including an in-cell charge control mechanism (i.e., pressure responsive switch of a type described herein) can be used in electric vehicle or hybrid electric vehicle batteries. Without limiting the scope of the present invention, batteries comprised of cells with in-cell charge control can range in sizes greater than 5 cm in length, height, and width, which are typical of those being developed commercially. It is, nonetheless, desirable to increase a cell's tolerance of elevated temperatures regardless of its size.

One embodiment of the present invention recognizes that judicious selection of cell component materials reduces or eliminates the detrimental effects of fast charging. Materials capable of providing functionality at high temperatures enable the cells to be charged at higher rates. Furthermore, it is desirable to design current carrying components of the cell to minimize internal cell resistance, as the heat produced by a cell during a high rate charge increases as the cell resistance increases. It is therefore desirable to provide low-resistance and heat-stable materials for fast charging. For example, in pressure responsive switches of the type described above, it may be desirable for the grommet, plug, insulator, pressure stop, and any other nonconductive components that are exposed to elevated temperatures during fast charging to comprise a thermally stable material. Otherwise, the components may fail during operation. It has been determined that certain properties of polymer materials allow the cell to function at high temperatures. In a highly preferred embodiment, a polymer having a “dry as molded” tensile strength greater than 75 MPa, a percent elongation at break less than or equal to 50%, and a heat deflection temperature at 263 psi greater than or equal to 100 degrees Celsius offer sufficient functionality at the elevated temperatures likely to be experienced during fast charging.

For example, FIG. 28A plots percent elongation at break as a function of tensile strength, and FIG. 28B plots heat deflection temperature as a function of tensile strength. FIGS. 28A and 28B illustrate that glass filled polyamides, such as glass filled nylon 6,6, glass filed nylon 6,12, and glass filed polyphthalamide, and aromatic polyamides such as non-glass filled polyphthalamide, as well as other polymers having a tensile strength greater than 75 Mpa and an elongation at break of less than 50% satisfy the above-mentioned characteristics and are highly preferred polymers for use in nonconductive cell components that will be exposed to elevated temperatures when fast charging. The glass content in the polyamide materials can range from 1% to 50% by mass, and more preferably between 5% and 12% by mass. It has also been found that polymers having a heat deflection temperature greater than 120 C, or more preferably greater than 200 C at 264 PSI are suitable for the above-described cell components. In some cases, it may be further desirable for the separator of the cell to be thermally stable, such as by using a polypropylene, or blended, or surface modified, or modified polypropylene or other such heat stable materials.

As discussed above, reducing cell resistance is desirable to limit the temperature increase during charging. It has been determined that highly conductive nonferrous alloy materials could be used for the current carrying metal components of a secondary electrochemical cell to lower the cell resistance. For instance, copper alloys such as beryllium-copper can be used, along with alternative metals having high thermal and electrical conductivity, including but not limited to silver plated electrical contacts or gold plated or Nickel contacts, in addition to nickel-plated steel contacts. It should be appreciated that cells include current-carrying components that are also exposed to alkaline electrolyte, such as conductive tab 30 and rivet 24 of FIGS. 2A and 2B, conductive pin 116 and conductive tab 118 of FIG. 6A, and connector 160 of FIG. 7. It is desirable that these components, in addition to being highly conductive, also be chemically resistant to caustic solutions. Nickel or Nickel alloys have been found to produce desirable results due to their high thermal and electrical conductivity and low cost.

Reduced resistance of current carrying components, or other components in direct contact with the current carrying components may be achieved by providing thicker electrode tabs, thereby reducing component resistance to electric current flow and also increasing heat transfer. For instance, referring to FIG. 6B, a size Sub C, F, C, or D (essentially any cell whose diameter is greater than 15 mm), can benefit from a thicker electrode tab 118, which is between 5/1000 and 20/1000 inch as illustrated. It should be further appreciated that a 188 can alternatively extend upwardly from each electrode 108 and contact rivet 116. Furthermore, a conductive disc 125 can connect the bottom of each electrode 106 to the outer can 110 in order to increase the conductivity of the current collector as is commonly practiced in the art. The accommodation of high charge rates within the cell while reducing the heat generated within the cell being charged further decreases the internal cell pressure. The reduction in pressure and heat increases length of time that the cell can be charged before the switch opens while reducing any chemical degradation of the cell's electrochemical capacity due to extended exposure to high temperatures.

It should be appreciated that the present invention is equally applicable all NiMH cells, including larger sized cells (e.g., size AAA, AA, and sub C) along with small format (e.g., NiMH) cells, for example button cells, coin cells and smaller cylindrical cells, such as N and AAAA size cells, and prismatic cells. It is intended that small size cells include those cells having volumes less than 3 cm³. One having ordinary skill in the art will appreciate that the embodiments discussed above in accordance with the present invention could be implemented in both larger sized NiMH cells and smaller sized NiMH cells. For instance, a pressure responsive switch in accordance with any embodiment described herein can be installed in both small format and large format NiMH cells. This increases the cell's usefulness, especially in applications of wireless devices such as GSM phones, PDAs, hearing aids, and headsets where fast charges (voltage levels between 1.2 and 2 V and current levels between 4 and 15 A) are especially desirable, as small format cells can be charged within a few minutes using the fast charging method in combination with any of the above-described pressure switches.

The present invention further recognizes that the safety and performance of conventional battery packs are maximized by first carefully matched the capacity of each cell in the pack to avoid overcharging or overdischarging at least once cell in the battery pack. Those skilled in the art recognize that overdischarging a cell in a battery pack can cause the positive and negative electrodes to reverse, and become the negative and positive electrodes, respectively. Accordingly, one embodiment of the present invention contemplates a plurality of secondary cells (including NiMH cells), at least one of which containing a pressure responsive switch, that protects against overcharge and overdischarge of individual cells in a battery string and further eliminates the requirement of carefully matching cells and enables a battery pack to be charged in only a matter of minutes. A battery pack is defined broadly herein as a plurality of cells electrically connected to produce a voltage and/or a current output greater than the output of one of the cells. The pack can be configured to provide a standard size battery (for example, when a plurality of AA or AAA size cells are connected to provide a size C or D battery), or the pack can be configured to provide a current and/or voltage output greater than standard size batteries, such as battery packs that are commonly used to operate cell phones, digital cameras, camcorders, power tools such as drills and screw drivers, personal digital assistants or portable computers.

It should be appreciated that a plurality of cells could be installed in a battery pack and connected in series within a charger that is configured to supply a constant voltage or constant current charge to the cell. In particular, referring now to FIGS. 26A-26C, various examples of such battery packs 370 include a plurality of cells 372 arranged in one or more strings, wherein each cell may contain a pressure responsive switch, in accordance with any of the aforementioned embodiments, depending on the type of connection between the cells and strings. It should be appreciated that the battery pack can provide a large battery of the type suitable for electric vehicle or hybrid electric vehicle batteries and the like, or alternatively can comprise a plurality of smaller cells (e.g., size AA or AAA) that, in combination, provide a size C or D cell.

FIG. 26A illustrates a battery pack 370 having a string 371 of cells 372 that are connected to a charger circuit 374 in series, such that the termination of charging by the opening of the switch contacts in any one of the cells will terminate charging of each cell in the series. This embodiment contemplates that a pressure responsive switch can be installed in all cells of the series. Accordingly, when the cell having the lowest charging capacity terminates charging, current will cease to flow through all cells in the string 371. As the cells remain in the charger after the initial charge termination, the switch in the most charged cell will iteratively close and open at a duty cycle, thereby permitting a charge to flow intermittently through all cells in the pack. The mismatched cells having a greater charging capacity will thus accept the intermittent charge (either constant current or constant voltage charge). The charging capacity of mismatched cells will decrease at a rate faster than that of the fully (or almost fully) charged cell(s), thereby enabling the discharge capacity of the mismatched cell(s) to recover relative to the fully charged cell(s). Advantageously, the present invention overcomes the need to carefully match cells in a given battery pack.

In accordance with an alternative embodiment, the string 371 can include one cell having a relatively low charging capacity. Because the charge capacity of that cell in the string 371 will not decrease to a level less than the other cells during normal operation (as all cells will be exposed to the same charge current and will also be discharged at the same rate), only that cell will contain a pressure responsive switch. Installing the switch in the cell having the lowest charge capacity thus ensures that none of the cells will become overcharged during operation so long as the charger A) senses the open circuit condition caused by the cell whose switch has opened, and B) terminates the charge to prevent 1) overcharging of those cells that do not include a pressure switch, and 2) charging those cells without a pressure switch to a level greater than the cell with the pressure switch. Alternatively, more than one (but less than all) of the cells in the string 371 can include a pressure switch. This embodiment recognizes that cost and resources will be conserved by providing a string of cells, wherein not every cell requires a pressure switch.

Referring now to FIG. 26B, a battery pack 370 includes a string 371 of cells 372 that are connected to the charger circuit 374 in parallel to increase the discharge current of the battery pack. Because the cells 372 are connected in parallel, a disconnection in the charging circuit of one cell will not discontinue the charge to all cells, but rather will increase the charging current available to the cells 372 whose switches have not opened. A pressure responsive switch can be installed in each cell, if desired, to prevent cell overcharge.

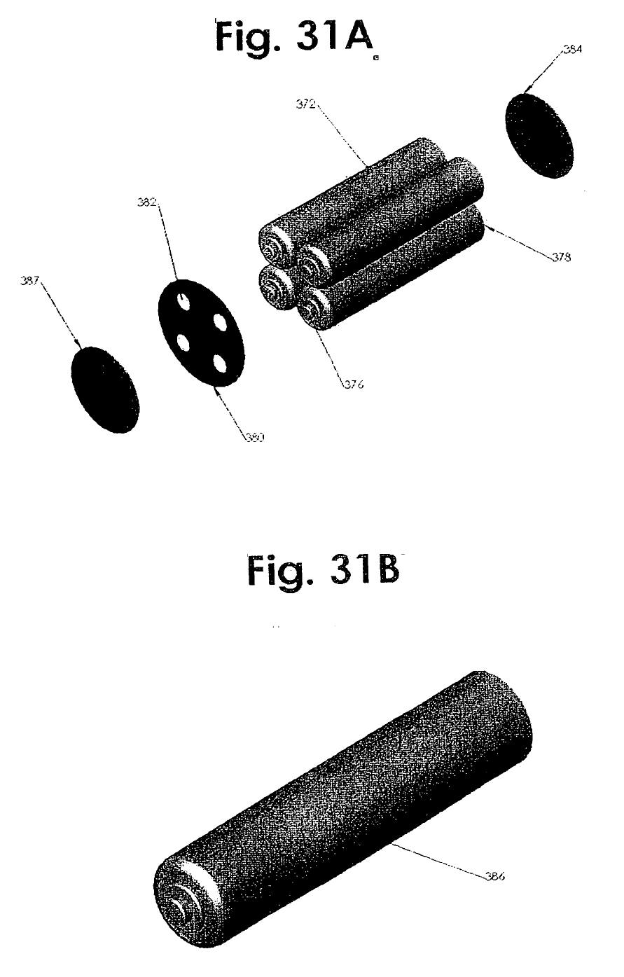

As illustrated in FIG. 31A, the battery pack 370 illustrated in FIG. 26B can be fabricated by providing a plurality of cells 372 (four in this embodiment). The positive terminals 376 and negative ends 378 of cells 372 are aligned. A conductive disc 380 is provided having a plurality of apertures 382 extending therethrough configured to receive the positive terminals 376. A pair of conductive circular discs 384 are provided and connected (preferably welded) to the positive and negative ends of cells 372. The cells are then encased in a battery pack housing such that the positive and negative ends of cells 372 are electrically connected to the respective terminal ends of the housing, which can be configured as a D or C size cell. The housing can alternatively be configured to provide any alternative cell that would benefit from the inclusion of a plurality of AAA or AA size cells.

FIG. 26C contemplates that a battery pack 370 could further include more than one string 371 and 373 of cells 372 connected in series, wherein each string 371 is connected in parallel. In this embodiment, the pressure switch disposed in any given individual cell 372 of string 371 will cease charging for all cells in that string. However, because strings 371 and 373 are connected in parallel, cells 372 in the remaining string 373 will continue charging until the pressure responsive switch in one of the cells of string 373 is actuated. It should be further appreciated that any number of strings may be connected, depending on the desired discharge capacity of the battery pack 370. It should thus be appreciated that a pressure responsive switch can be installed in only one cell of each string, as described above, or alternatively in each cell of one or more strings.

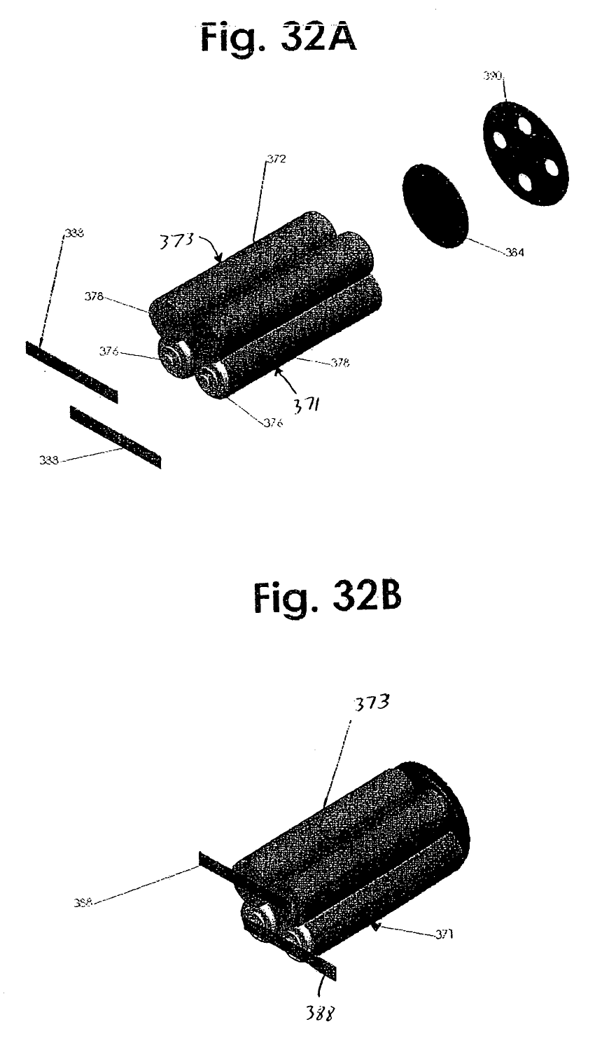

The fabrication of battery pack 370 illustrated in FIG. 26C is illustrated in FIGS. 32A-B. In particular, the first string 371 of cells 372 is provided with the positive terminals 376 aligned. The second string 373 is provided with the negative terminals 378 aligned with the positive terminals of the first string 371. A pair of conductive tabs 388 is provided. One tab 388 connects the positive terminal ends 376 of the first string 371, while the other tab connects the negative terminal ends 378 of the second string 373. The tabs 388 thus connect cells of each string in parallel. The strings 371 and 373 are connected in series via conductive disc 384 that is connected (preferably welded) to the ends of cells 372 opposite tabs 388. An insulating member 390 fits over disc 384 to prevent the disc from being electrically connected to any external members. While disc 390 includes four apertures 392 that would match the positive terminal ends of four cells (to accommodate the cell terminal ends 376), though only a pair of apertures 392 need to be formed in disc 390 in accordance with this embodiment to correspond with the terminal ends 376 of string 373. Electrical connection to the cells 372 is thus provided only via tabs 388. Cells 372 are then inserted into a battery housing of desirable size.

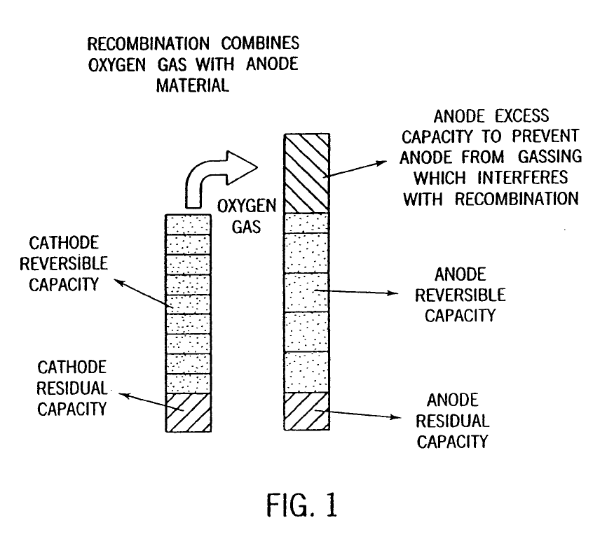

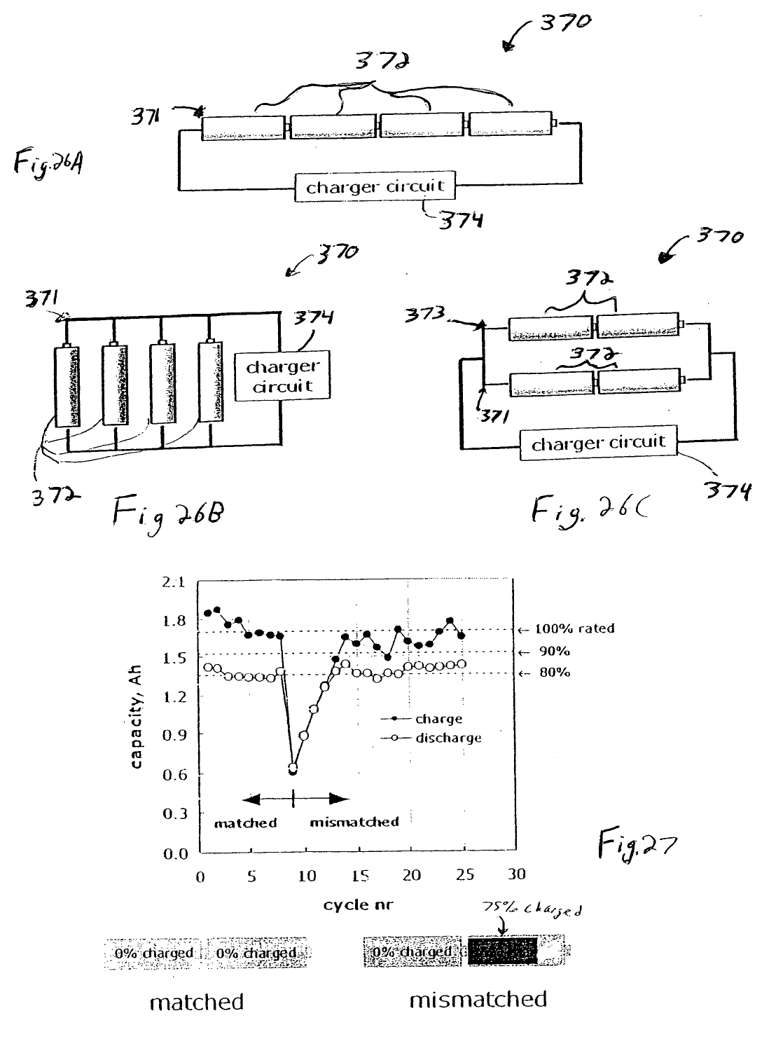

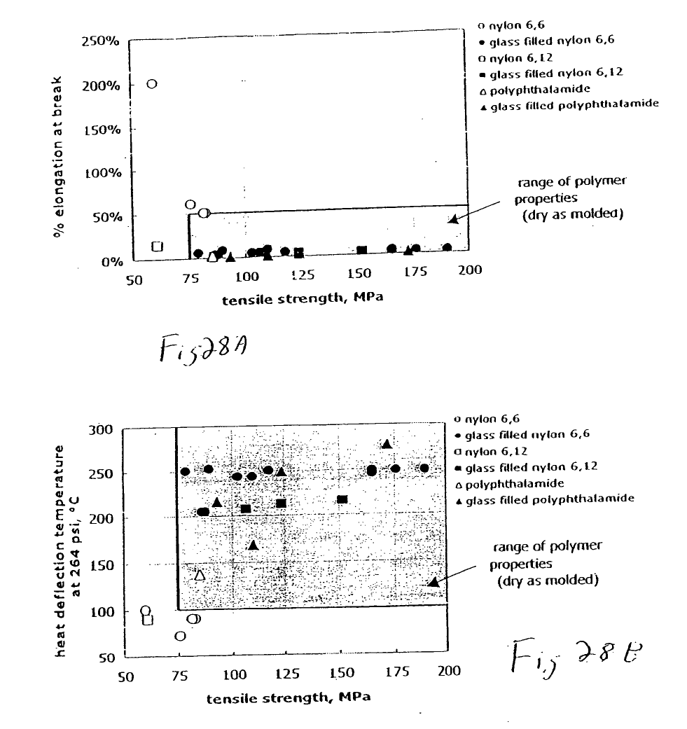

The ability for mismatched cells in a given string to recover their capacity after only a few charge-discharge cycles depends upon the length of time that the cells are left in the charger after the switch of the first cell begins to iteratively open and close. For example, referring to FIG. 27, two matched cells are connected in series during cycles 1-8, and the charge and discharge capacity of the battery remains relatively constant. At cycle 9, a pair of mismatched cells (one of which having only a 25% charging capacity) is connected in series. When the cells are charged, one cell has a greater charge capacity than the other. However, during the charging cycle, if the cells remain in the charger past the time when the lower charge capacity cell switch begins iterating, the higher charge capacity cell will become charged at a higher rate relative to the iterating cell due to the recombination reaction (See FIG. 1) present in the iterating cell when the switch of the iterating cell is closed, thereby allowing current to flow through all connected cells. Because the remaining cells that are not fully charged are not yet undergoing a recombination reaction, they will continue to charge even as the iterating cell undergoes the recombination reaction. This trend will continue for a number of cycles (5 cycles total in accordance with the illustrated embodiment) until the capacities of the two cells become equalized. Of course, the number of cycles is dependent upon the length of time that a charge is applied to the cells after the first cell begins to iterate.

It is well known that the discharge capacity of cells connected in parallel will reach equilibrium during discharge, as a higher current output is produced by the cell having the higher discharge capacity. The pressure responsive switch of the present invention also enables a plurality of mismatched cells connected in series to become matched over a period of time.

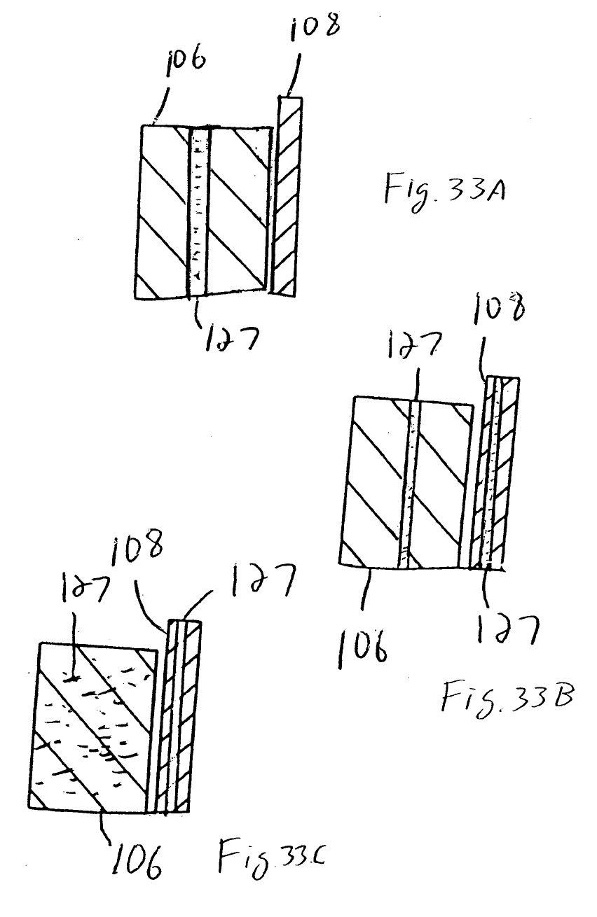

In accordance with an alternate embodiment of the invention, it is recognized that a user may prefer a shorter charging time, even if this results in a slightly reduced cell capacity during use. While the industry trend is to constantly strive to increase the capacity of the cells, the present embodiment recognizes that it may be desirable to reduce the capacity of the rechargeable cells, for instance by manufacturing electrodes of shorter lengths, or lesser thicknesses, or with filler materials that are inert (defined herein as being non-reactive to cell components or chemicals), thereby reducing the volume of active cell components, as is described with reference to FIGS. 33A-C. It is anticipated that between 20 and 40% of the active cell components, including anode and cathode, can reduce the time necessary to charge the cell, and further can increase cell efficiency, as will now be described.

For instance, referring to FIG. 33A, a layer 127 of inert material is inserted into electrode 106 such that electrode material is disposed on either side of layer 127. This increases the overall thickness of electrode 106, causing the thickness of electrode 108 to be reduced. Alternatively, a layer 127 of inert material can be inserted into both electrodes 106 and 108 as illustrated in FIG. 33B. Alternatively still, inert material 127 can be intermixed within either electrode (electrode 106 as illustrated in FIG. 33C), and an inert layer 127 can be inserted into the other electrode 108. Alternatively, the thickness of the other electrode can be reduced. Alternatively still, the inert material can be intermixed with both electrodes 106 and 108. Alternatively still, a combination of reducing electrode thickness, inserting an inert layer, and intermixing inert material in either or both electrodes can reduce the active material. The embodiments described above with reference to FIGS. 33A-C maintain the axial length (and hence the contact surface area) while decreasing the volume of active material. Because cell efficiency is determined by the ratio of surface contact area per volume of active cell materials, the embodiments illustrated in FIGS. 33A-C, and their equivalents, increase cell efficiency.

Alternatively, the length of the electrodes can be reduced. While this would decrease the surface contact area (hence not increasing cell efficiency), the decrease in electrode length would result in a reduced length of time necessary to charge the cell.

In particular, the reduction of active volume in rechargeable cells (e.g., to achieve a discharge capacity of 700-1600 mAh for size AA cells, and 200-650 mAh for size AAA cells) has been found to decrease the charge time to only a few minutes when fast-charged (as described above) at constant voltage for cells with a pressure responsive switch constructed in accordance with any of the embodiments described herein.

Such charge times render a NiMH rechargeable cell more competitive with the fast charge time of supercapacitors, while preserving the advantages inherent to a battery. For example, FIG. 29 illustrates charge capacity as a function of charge time. The charge capacity accepted by a size AA NiMH cell having a pressure responsive switch in accordance with any of the above-described embodiments is charged to 800 mAh after only 5 minutes of charging, and 1 Ah after only 7 minutes of charging. One benefit of a NiMH cell is its relatively flat discharge voltage, while supercapacitors exhibit a steeply sloping discharge voltage curve.

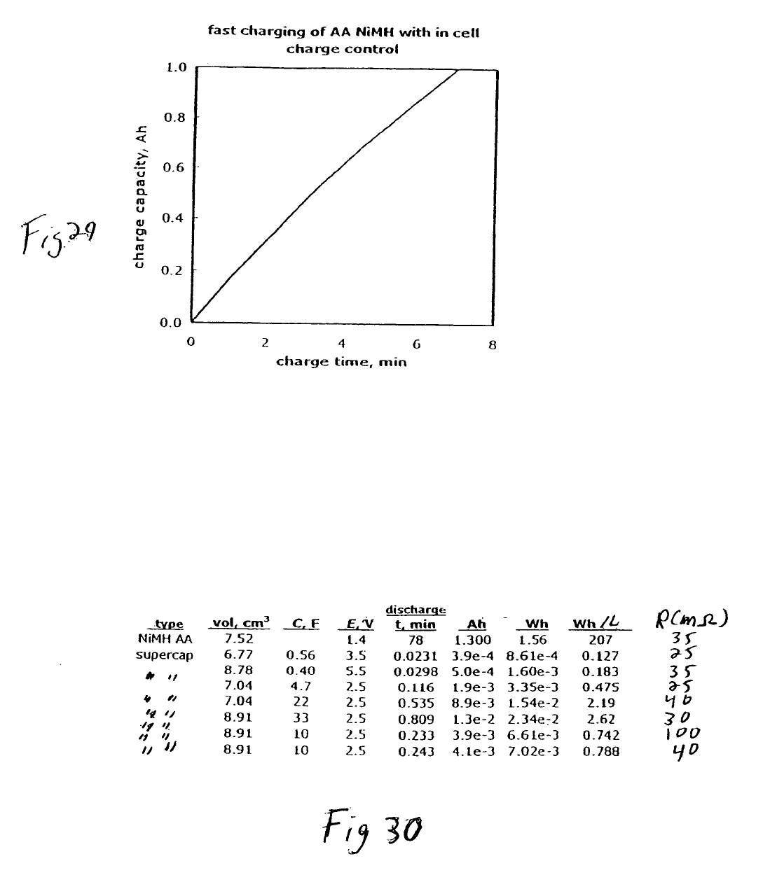

Other advantages of a NiMH AA cell are illustrated in FIG. 30. Since supercapacitors are not offered commercially in AA sizes, FIG. 30 sets forth comparisons between a NiMH AA cell and a plurality of supercapacitors of similar volume (the NiMH cell and supercapacitors are herein collectively referred to as “cells” for the purposes of clarity and convenience). In particular, the volume of the cells is illustrated, along with the rated capacitance of each super capacitor measured in Farads. The nominal electromotive force (E) is measured in volts (V) for all cells, as is the discharge time in minutes. The charge capacity delivered is measured in Ampere-hours (Ah) for each cell, as is the energy delivered which is measured in Watt-hours (Wh). Finally, the cells are compared on the basis of energy density, measured in Wh per liter, and the internal resistance of each cell is measured in milli-ohms (mW). It can be observed that the energy density of the NiMH battery is orders of magnitude greater than the energy density of the supercapacitors while the internal resistance is similar to the supercapacitors, thereby enabling the NiMH battery to have a higher discharge rate.

The above description has been that of the preferred embodiment of the present invention, and it will occur to those having ordinary skill in the art that many modifications may be made without departing from the spirit and scope of the invention. In order to apprise the public of the various embodiments that may fall in the scope of the present invention, the following claims are made.

We claim:

1. A rechargeable electrochemical cell defining a positive and a negative terminal, the cell comprising:
(a) an outer can defining an internal cavity, and a positive and negative electrode disposed in the internal cavity; and
(b) a switch assembly including:
i. a flexible member comprising a material having a heat deflection temperature greater than 100 C at 264 PSI and a tensile strength greater than 75 Mpa, wherein the flexible member flexes from a first position towards a second position in response to internal cell pressure;
ii. a first conductive element in electrical communication with the positive terminal;
iii. a second conductive element in electrical communication with the positive electrode, and in removable electrical communication with the first conductive element, wherein the second conductive element is in mechanical communication with the flexible member; and
wherein the first and second conductive elements are removed from electrical communication when the flexible member flexes towards the second position in response to an internal pressure exceeding a predetermined threshold.

2. The electrochemical cell as recited in claim 1, wherein the flexible member returns to the first position from the second position when the internal pressure drops below the predetermined threshold.

3. The electrochemical cell as recited in claim 1, wherein the flexible member material is selected from the group consisting of a glass filled polyamide and an aromatic polyamide.

4. The electrochemical cell as recited in claim 3, wherein the glass filled polyamide is selected from the group consisting of glass filled nylon 6,6, glass filed nylon 6,12, and glass filed polyphthalamide.

5. The electrochemical cell as recited in claim 4, wherein the glass filled polyamide has a glass content between 1% and 50% by mass.

6. The electrochemical cell as recited in claim 5, wherein the glass filled polyamide has a glass content between 5% and 12% by mass.

7. The electrochemical cell as recited in claim 1, wherein the flexible member material has a tensile strength greater than 75 Mpa, and less than a 50% elongation at break

8. The electrochemical cell as recited in claim 1, wherein the flexible member material has a heat deflection temperature greater than 120 C at 264 PSI.

9. The electrochemical cell as recited in claim 3, wherein the aromatic polyamide comprises polyphthalamide.

10. The electrochemical cell as recited in claim 1, further comprising a separator, disposed between the positive and negative electrodes, wherein the separator comprises a polypropylene.

11. The electrochemical cell as recited in claim 1, wherein one of the positive and negative electrodes include an inert material.

12. The electrochemical cell as recited in claim 11, wherein the inert material comprises a layer that is inserted into at least one of the positive and negative electrodes.

13. The electrochemical cell as recited in claim 11, wherein the inert material is intermixed within at least one of the positive and negative electrodes.

14. The electrochemical cell as recited in claim 11, wherein the cumulative volume of positive and negative electrode material is reduced between 20% and 40%.

15. The electrochemical cell as recited in claim 11, wherein the electrochemical cell is a size AA cell having a discharge capacity between 700 and 1600 mAh.

16. The electrochemical cell as recited in claim 11, wherein the electrochemical cell is a size AAA cell having a discharge capacity between 200 and 650 mAh.

17. The electrochemical cell as recited in claim 1, wherein the cell is a nickel metal hydride cell.

18. The electrochemical cell as recited in claim 17, wherein the cell is a small format cell.

19. The electrochemical cell as recited in claim 17, wherein the cell is a large format cell.

20. The electrochemical cell as recited in claim 1, wherein the internal cavity defines an open end, the cell further comprising a terminal end cap enclosing the open end.

21. The electrochemical cell as recited in claim 20, wherein the flexible member divides the internal cavity into a cell interior and an end cap interior, and wherein a channel extends axially through the flexible member linking the internal cavity with the cell interior.

22. The electrochemical cell as recited in claim 21, further comprising a conductive rivet extending through the channel and a conductive tab electrically connecting the rivet to the positive electrode, wherein the rivet is in electrical communication with the second conductive element.

23. The electrochemical cell as recited in claim 22, wherein at least one of the rivet and the conductive tab comprise a nonferrous alloy material.

24. The electrochemical cell as recited in claim 23, wherein the nonferrous alloy material is selected from the group consisting of beryllium-copper, a silver plated electrical contact, a gold plated contacts, nickel, and a nickel plated contact.

25. The electrochemical cell as recited in claim 24, wherein the contact comprises steel.

26. The electrochemical cell as recited in claim 21, further comprising an outlet extending through the terminal end cap.

27. The electrochemical cell as recited in claim 26, further comprising a venting member that blocks the channel while the flexible member is in the first position.

28. The electrochemical cell as recited in claim 27, wherein the venting member becomes removed from the channel in response to a predetermined internal pressure threshold.

29. The electrochemical cell as recited in claim 28, wherein the predetermined internal pressure threshold is substantially equal to the internal pressure threshold that biases the flexible member to the second position.

30. The electrochemical cell as recited in claim 28, wherein the predetermined internal pressure threshold is greater than the internal pressure threshold that biases the flexible member to the second position.

31. The electrochemical cell as recited in claim 28, wherein the venting member comprises a plug disposed in the channel that is removed from the channel in response to internal pressure.

32. The electrochemical cell as recited in claim 31, wherein the internal pressure biases the plug into the end cap interior.

33. The electrochemical cell as recited in claim 31, wherein the plug is attached to the terminal end cap, and wherein the channel is removed from the plug when the flexible member is in the second position.

34. The electrochemical cell as recited in claim 28, wherein the venting member further comprises a transverse disc blocking fluid flow between the cell interior and the end cap interior, wherein the transverse arm breaks in response to internal cell pressure.

35. The electrochemical cell as recited in claim 1, wherein the flexible member further comprises a necked-down disc portion that fails when the internal cell pressure reaches a predetermined threshold.

36. The electrochemical cell as recited in claim 1, wherein the flexible member extends substantially laterally.

37. The electrochemical cell as recited in claim 1, wherein the flexible member extends radially inwardly from the can.

38. The electrochemical cell as recited in claim 1, wherein the flexible member is symmetrically positioned with respect to the can.

39. A battery pack comprising:
a plurality of electrochemical cells defining positive and negative terminals, at least one of the cells including:
(a) an outer can defining an internal cavity, and a positive and negative electrode disposed in the internal cavity; and
(b) a switch assembly including:
i. a flexible member that flexes from a first position towards a second position in response to internal cell pressure;
ii. a first conductive element in electrical communication with the positive terminal;
iii. a second conductive element in electrical communication with the positive electrode, and in removable electrical communication with the first conductive element, wherein the second conductive element is in mechanical communication with the flexible member; and
wherein the first and second conductive elements are removed from electrical communication when the flexible member flexes towards the second position in response to an internal pressure exceeding a predetermined threshold.

40. The battery pack as recited in claim 39, wherein the electrochemical cells are connected in series.

41. The battery pack as recited in claim 39, wherein the electrochemical cells are connected in parallel.

42. The battery pack as recited in claim 39, further comprising at least two strings of cells connected in series, wherein each string is connected in parallel.

43. The battery pack as recited in claim 39, wherein the electrochemical cells are configured to provide one of a size C and D electrochemical cell.

44. The battery pack as recited in claim 39, wherein the cell including the flexible member has a lower charge capacity than the remaining cells.

45. The battery pack as recited in claim 39, wherein all electrochemical cells further comprise elements (a) and (b).

46. The battery pack as recited in claim 39, wherein the flexible member a tensile strength greater than 75 Mpa and less than a 50% elongation at break

47. The battery pack as recited in claim 39, wherein the flexible member has a heat deflection temperature greater than 120 C at 264 PSI and a tensile strength greater than 75 Mpa.

48. The battery pack as recited in claim 47, wherein the flexible member material has a heat deflection temperature greater than 200 C at 264 PSI.

49. A method of charging a battery pack as recited in claim 39, wherein the battery pack includes cells electrically connected in series, wherein one of the cells is mismatched with a higher charge capacity relative to the remaining cells connected in series, the steps comprising:
1) applying a charge through the series of cells until the flexible member in one of the cells opens;
2) removing the charge through the series of cells until the flexible member returns to the first position; and
3) reapplying the charge through the series of cells.

50. The method as recited in claim 49, wherein step (3) further comprises equalizing the charge capacity of the mismatched cell with the remaining cells.

51. The method as recited in claim 49, further comprising predetermining the cell that will open during step (1), and providing that cell with the flexible member.

52. A method of charging a battery pack as recited in claim 39, wherein the battery pack includes cells electrically connected in parallel, wherein one of the cells is mismatched with a higher charge capacity relative to the remaining cells, the steps comprising:
1) applying a charge through the cells until the flexible member in one of the cells opens;
2) iterating the flexible member between a closed and open position; and
3) applying the charge to the higher charge capacity cell during step (2)

53. A method for charging an electrochemical cell of the type including (a) an outer can defining an internal cavity with an open end, a positive and negative electrode disposed in the internal cavity, and a terminal end cap enclosing the open end; and (b) an end cap assembly including: i. a flexible member that extends radially inwardly from the can and flexes from a first position towards a second position in response to internal cell pressure, ii. a first conductive element in electrical communication with the terminal end cap, and iii. a second conductive element in electrical communication with the positive electrode, and in removable electrical communication with the first conductive element, wherein the second conductive element is in mechanical communication with the flexible member, the steps comprising:
(A) providing a charge including at least one of a voltage level between 1.2 and 2 V and a current level between 4 and 15 A; and
(B) flexing the flexible member towards the second position to remove the first and second conductive elements from electrical communication when internal cell pressure exceeds a predetermined threshold,

54. The method as recited in claim 53, wherein step (A) further comprises providing a voltage between 1.2 and 1.65 V.

55. The method as recited in claim 54, wherein step (A) further comprises providing a voltage between 1.6 and 1.65 V.

56. The method as recited in claim 54, wherein step (A) further comprises providing a voltage between 1.2 and 1.6 V.

57. The method as recited in claim 53, wherein step (A) further comprises providing a charge voltage at a predetermined level between 1.2 and 2.0 V, and decreasing the charge voltage based on a predetermined cell characteristic.

58. The method as recited in claim 57, wherein the predetermined characteristic is cell temperature.

59. The method as recited in claim 58, wherein step (A) further comprises providing a variable voltage that is not time dependent.

60. The method as recited in claim 58, wherein step (A) further comprises providing a constant voltage that steps down after the expiration of a predetermined length of time.

61. The method as recited in claim 57, wherein step (A) further comprises preventing the applied voltage from decreasing below the predetermined level.

62. The method as recited in claim 57, wherein the predetermined level is substantially equal to 1.65 V.

63. The method as recited in claim 57, further comprising terminating step (A) upon the expiration of a predetermined duration of time.
